(19) United States
(12) Patent Application Publication
(10) Pub. No.: US 2025/0033832 A1
(43) Pub. Date: Jan. 30, 2025

(54) METALLIC BEVERAGE CONTAINERS WITH CORROSION INHIBITORS AND METHODS OF MANUFACTURING THE SAME

(71) Applicant: Ball Corporation, Westminster, CO (US)

(72) Inventors: Scott K. Brendecke, Superior, CO (US); John Troisi, Denver, CO (US); Adam P. Stowitts, Arvada, CO (US)

(73) Assignee: Ball Corporation, Westminster, CO (US)

(21) Appl. No.: 18/785,785

(22) Filed: Jul. 26, 2024

Related U.S. Application Data
(60) Provisional application No. 63/515,914, filed on Jul. 27, 2023.

(51) Int. Cl. B65D 25/14; B21D 22/20; B21D 35/00; B21D 51/26

(52) U.S. Cl. CPC B65D 25/14; B21D 22/201; B21D 35/005; B21D 51/26

(57) ABSTRACT

Metallic container bodies having a corrosion inhibitor and internal coating are provided herein, along with a system and a method of manufacturing metallic container bodies with one or more corrosion inhibitors. The corrosion inhibitor can be applied between the internal coating and the metal surface of the container body, on top of the internal coating such that it is between the internal coating and a beverage stored in the container body, or mixed in with the internal coating. During the container production process, the corrosion inhibitor could be applied: (1) in a washer; (2) after the washer but before the dryer; (3) after the dryer; (4) during the application of the internal coating by mixing the corrosion inhibitor with the internal coating or after the internal coating has been sprayed but not yet cured; (5) after the application and curing of the internal coating but before necking operations; or (6) after necking operations but before the palletizer.

### CROSS REFERENCE TO RELATED APPLICATIONS

This application claims priority and benefits under 35 U.S.C. § 119 (e) to U.S. Provisional Patent Application Ser. No. 63/515,914 filed on Jul. 27, 2023, which is incorporated herein in its entirety by reference.

### FIELD

The present disclosure relates generally to metallic container bodies with corrosion inhibitors and methods of manufacturing metallic container bodies with corrosion inhibitors.

### BACKGROUND

Containers, and more specifically metallic container bodies, are typically manufactured in two pieces: the container body and a closure. The closure may be an end closure which is used to seal a two-part beverage container. In other embodiments, the closure is a roll-on pilfer proof closure used to seal a metallic bottle.

Background on how a metallic container is made is provided in the video “The Ingenious Design of the Aluminum Beverage Can,” available at https://www.youtube.com/watch?v=hUhisi2FBuw, and the video “How it's made—Aluminium cans,” available at https://www.youtube.com/watch?v=V4TVDSWuR5E. Metallic container bodies are frequently produced by a draw and wall ironing (DWI) process. Production lines generally start with an uncoiler that unrolls a coil of an aluminum sheet. Two or more coils of aluminum sheet may be used each day for a production line. The aluminum sheet is fed into a cupper which cuts circular blanks from the aluminum sheet and forms the blanks into cups. The cups are then transported by a conveyor to a bodymaker. The bodymaker forms the cups into container bodies. The container bodies are subsequently transported to downstream equipment that perform additional operations on the container bodies. The equipment downstream from the bodymakers may include trimmers, washers, ovens, decorators, internal coaters, neckers, flangers, and palletizers.

The container body is shipped to a filler company, filled with the beverage, and then the end closure is attached to the container body. The interior surface of the container body, specifically surfaces of the sidewall and bottom end, is in contact with the beverage for weeks, months, or even years. Depending on the composition of the beverage, the beverage may corrode and/or interact with the container's metallic sidewall. Specifically, the beverage or its ingredients will contact the aluminum oxide/aluminum surface of the container sidewall and bottom end.

In order to prevent the beverage from corroding and damaging the container and to preserve the flavor of the beverage, a coating is typically applied to the interior surface of the container body during the container body manufacturing process. Typically, the inside of the metallic container is lined by spray coating an epoxy lacquer or polymer to protect the aluminum from being corroded by acidic contents such as carbonated beverages and imparting a metallic taste to the beverage.

There are a number of disadvantages and/or drawbacks to applying a coating alone to the interior surface of the container body. For example, if a highly corrosive beverage is to be put into the container (e.g., beverages with high alcohol content, alcoholic beverages with salt such as margaritas, sport drinks with high salt/electrolyte content, acidic drinks like carbonated drinks and energy drinks, etc.), then a more effective or thicker internal coating may be needed to protect the metallic container body and reduce or eliminate the contact between the beverage and the aluminum oxide/aluminum surface of the container body. However, spraying a thicker internal coating means more time is required to manufacture a container body, more coating material is needed, and the container body is more expensive to manufacture. Another disadvantage of applying a thicker internal coating is that the coating will end up thicker at the bottom of the container body than at the top of the sidewall because the spray-on coating runs (i.e., slides down) the side of the container sidewall as it dries, and the thick coating will blister if it gets too hot during the curing process. Alternatively, multiple layers of internal coatings may be applied to the container body, i.e., apply a second layer after the first layer of internal coating is cured, but this also increases the time and expense needed to manufacture a metallic container body. Additionally, the coatings may absorb some of the beverage's flavor, which is not ideal for consumers or beverage makers. Further, some coatings do not work for alcoholic beverages because the alcohol soaks into the coating.

### SUMMARY

Due to the numerous limitations associated with the prior art described above, the following disclosure describes an improved metallic container body with a corrosion inhibitor on the interior surface and methods of manufacturing a metallic container body with a corrosion inhibitor. This novel feature provides a container body that is suitable for use with highly corrosive beverages and significantly improves the integrity of the container body and the flavor of a beverage stored therein.

Note that the embodiments described herein may be applied to metallic packaging of any type and shape. For example, embodiments of the present disclosure may be applied to metallic cans, metallic container bodies, beverage containers, can ends (also called end closures), metallic cups, and metallic bottles. Additionally, “interior surface” may be used interchangeably with “inner surface” to mean the side of the container touching the beverage once the container is filled. “Outer surface” may be used interchangeably with “exterior surface” to mean the side of the container that the user touches to hold the container body.

More specifically, when the description or claims say that the corrosion inhibitor is positioned on or applied to the inner surface of the container, the corrosion inhibitor may be positioned directly on the metallic (e.g., aluminum oxide/aluminum) surface of the container or may be positioned directly on the internal coating, if the internal coating is positioned directly on the metallic surface of the container. When the description or claims discuss the inner surface of the container generally, it typically means the most inner layer of the container, which may be metal or a coating or otherwise such that the inner surface is in contact with the beverage put into the container. If the description or claims use the term “directly,” it means that the item being discussed is in direct contact with the other item being discussed. It is possible for both the internal coating and the corrosion inhibitor to be positioned on the inner surface of the container and such a statement means that either: (1) the internal coating is directly touching the metal container surface and the corrosion inhibitor is on top of the internal coating such that the corrosion inhibitor is touching the beverage put into the container, (2) the corrosion inhibitor is directly touching the metal container surface and the internal coating is on top of the corrosion inhibitor such that the internal coating is touching the beverage put into the container, or (3) the internal coating and corrosion inhibitor are mixed and both touch the metal surface of the container and both touch the beverage put into the container.

Moreover, the internal coating layer may have some holes (like a slice of Swiss cheese) and if the internal coating is applied directly on the metal container surface and the corrosion inhibitor is applied on top of the internal coating, some of the corrosion inhibitor will touch the metal container through the holes in the internal coating layer. Similarly, if the corrosion inhibitor is applied on top of the internal coating, the corrosion inhibitor layer may also have some holes and the beverage would touch the internal coating through the holes in the corrosion inhibitor layer. The opposite is true, meaning if the corrosion inhibitor is applied directly on the metal container surface and the internal coating is applied on top of the corrosion inhibitor, the corrosion inhibitor layer may have some holes such that the internal coating will touch the metal container surface through the holes in the corrosion inhibitor layer and the beverage may touch the corrosion inhibitor through holes in the internal coating layer.

Aspects of various embodiments of the present invention include providing a metallic container (including container or can bodies, can ends, and bottles) with a corrosion inhibitor that allows for some level of contact between the beverage or its ingredients and the metal (e.g., aluminum oxide/aluminum) surface of the container body. The addition of a corrosion inhibitor will lessen or eliminate contact between the beverage (or other product held by the container body) and the container surface, which is desired to protect the integrity of the container and the flavor of the beverage. Advantages of adding the corrosion inhibitor during the container production process at the plant include the amount and uniformity of the coverage may be controlled and there will be less variation for the customer (i.e., beverage maker/filler) than if a corrosion inhibitor were added at some point after the aluminum container has left the production facility.

Thus, it is an aspect of embodiments of the present disclosure to add corrosion inhibitors during the process of manufacturing a container body to improve the barrier properties between the contained liquid and the metal surface of the container body.

In some embodiments, the corrosion inhibitors may be selected from a wide range of compounds including polyphenols, terpenes, polysaccharides, vitamins, carboxylic acids, proteins, tannins, anthraquinones, amino acids, sterols, sugars, avonoids, and alkaloids. Even more generally, the corrosion inhibitors may be compounds that contain P, N, S, O (phosphorus, nitrogen, sulfur, oxygen) atoms and multiple bonds in their structure, which serve as bonding centers for their adsorption on the surface of the aluminum materials.

Organic compounds having nitrogen, oxygen, and sulfur have anticorrosion properties. Specifically, electron rich organic compounds have good inhibition capabilities in acidic environments. Primary, secondary, tertiary, and quaternary amines also are good corrosion inhibitors in an acidic medium. Corrosion can be controlled by the application of aliphatic and aromatic amines. Aloe vera is environmentally friendly and can be a good corrosion inhibitor at higher concentrations, but is not as effective at lower concentrations. Oxides of metals and phosphates of metals may also be used as corrosion inhibitors. For coating applications, rubber polymers and silicon may be used to protect the metal surface from corrosion. Nano coatings of organic and inorganic materials on a metal surface may produce good corrosion inhibition properties and improve the life of the metal material. Several types of nano coatings may be positioned on (or applied to) the surface of materials, for example, nano composite thin film coating, thermal barrier coating, top layer coating, nano structural change, and conversion coating. Various embodiments of the present disclosure may use the aforementioned corrosion inhibitors.

Examples of anodic inorganic corrosion inhibitors are nitrates, molybdates, sodium chromates, phosphates, hydroxides, and silicates. Some examples of inorganic cathodic inhibitors are the ions of magnesium, zinc, and nickel that react with the hydroxyl (OH−) of the water forming the insoluble hydroxides (e.g., Mg(OH)2, Zn(OH)2, Ni(OH)2), which are deposited to the cathodic site of the metal surface to protect it. Similarly, polyphosphates, phosphonates, tannins, lignins, and calcium salts are corrosion inhibitors that present the same reaction mechanism. Other good organic corrosion inhibitors are amines, urea, mercaptobenzothiazole (MBT), benzotriazole e toliotriazol, aldehydes, heterocyclic nitrogen compounds, sulfur-containing compounds, and acetylenic compounds. Additionally, ascorbic acid, succinic acid, tryptamine, caffeine, and extracts of natural substances are good corrosion inhibitors. Various embodiments of the present disclosure may use the aforementioned corrosion inhibitors.

Organic corrosion inhibitors commonly used include imidazolines, aldehydes, acetylenic alcohols, and alkyl phenones. Alternatives that are environmentally safer include amino acids, natural extracts, carbohydrates, ionic liquids, and pharmaceutical compounds. These compounds include nitrogen, sulfur, and oxygen that exhibit efficient adsorptions over the metallic substrates through sharing their lone pair of electrons. Various embodiments of the present disclosure may use the aforementioned corrosion inhibitors.

Plant extracts with higher total phenolic content have higher inhibition effectiveness. Examples include polyphenols, terpenes, carboxylic acids, and alkaloids. However, polyphenol-based extracts seem to satisfy most of the demands of a composite anti-corrosion/anti-biodeterioration product, in addition to having the advantage of being less toxic than other plant extracts, e.g., alkaloid extracts. The presence of oxygen, nitrogen, and sulfur atoms containing lone pairs of electrons may aid the additive's adsorption onto metal surfaces to inhibit corrosion. Plant-derived gums contain polysaccharide compounds rich in nitrogen and oxygen atoms, which serve as adsorption centers, act as corrosion inhibitors. Also, gum-metal complexes are formed that act as a barrier layer and isolate the metal surface from the corrosive environment. Natural honey and animal glue (i.e., boiled animal connective tissue) also have anticorrosive properties. Various embodiments of the present disclosure may use the aforementioned corrosion inhibitors.

In some embodiments, food grade tartaric acid and/or trisodium citrate are used as corrosion inhibitors.

In some embodiments, azole derivatives, mercapto compounds, quinolines (especially 8-hydroxyquinoline), organic dyes, and polymers are used as organic corrosion inhibitors since these are known to work well on aluminum and its alloys in different alkaline and chloride solutions.

In various embodiments, plant extracts are used as natural additives providing anti-corrosion properties in coating applications. Specifically, plant extracts that contain compounds with the presence of sulfur, nitrogen, oxygen, and phosphorus make good corrosion inhibitors as these compounds are adsorbed on the metal surface and block the active sites to reduce the rate of corrosion. More specifically, the henna tree plant, banana tree leaves, and green Capsicum annuum fruit make good corrosion inhibitors for metal surfaces. In alternative embodiments, acrylic or epoxy resins or other polymer resins may be used as corrosion inhibitors for coating applications. Inorganic materials, such as chromates, dichromates, phosphates, and arsenates, are good corrosion inhibitors but are very toxic and harmful to the human body. Therefore, these inorganic materials could only be used in embodiments of the present disclosure if they are positioned between the metal container and the internal coating such that the beverage in the container does not directly contact these inorganic materials or only minimally directly contacts these inorganic materials.

It is one aspect of embodiments of the present disclosure to provide a metallic container body with a corrosion inhibitor that does not affect the taste/flavor of the beverage, protects the container body from corrosive beverages, and is inexpensive to apply during the manufacturing process. It is possible that the corrosion inhibitor is inexpensive in part because very little is needed. Alternatively, the actual corrosion inhibitor could be inexpensive.

It is another aspect of embodiments of the present disclosure to provide a metallic container body with a corrosion inhibitor that has bigger molecules than the corrosive molecules. Thus, in some embodiments, the molecules of the corrosion inhibitor fill or block holes or thin spots in the internal coating such that the corrosive molecules cannot touch the metallic container body. In additional or alternative embodiments, the bigger molecules of the corrosion inhibitor prevent the beverage (e.g., corrosive molecules) from touching the internal coating and/or the metallic sidewall and the closed endwall of the container body.

Thus, it is one aspect of various embodiments of the present disclosure to provide a metallic container body with an internal coating that includes a corrosion inhibitor to protect the aluminum oxide/aluminum surface of the container body from the beverage and vice versa. The corrosion inhibitor may be applied: (1) between the internal coating and the aluminum oxide/aluminum surface of the container body, (2) on top of the internal coating such that the corrosion inhibitor is between the internal coating and the beverage, or (3) mixed in with the internal coating.

It is another aspect of the present disclosure to provide a metallic container body that leaves the manufacturing facility and arrives at the filling location with a corrosion inhibitor.

There are six possible areas in the container production process where the corrosion inhibitor(s) could be applied: (1) in the metallic container body washer; (2) after the washer but before the dryer (known as a “dry off oven”); (3) after the dry off oven; (4) during the application of the internal coating by mixing with the internal coating or after the internal coating has been sprayed but before it is cured; (5) after the application and curing of the internal coating but before necking operations; or (6) after necking operations but before the palletizer. The location of the corrosion inhibitor application will depend on the corrosion inhibitor used, the desired results, the beverage (or other product) to be put into the container body, and the specific manufacturing plant layout.

One advantage of applying the corrosion inhibitor after the internal coating (i.e., at Area 5 or Area 6) and one variation of Area 4 (i.e., after the internal coating has been sprayed but before it is cured) is that the corrosion inhibitor can fill in the holes, thin spots, or pores in the internal coating.

In some embodiments, the corrosion inhibitor is one single compound applied to the inside of the metallic container body. In other embodiments, the corrosion inhibitor is multiple compounds applied to the inside of the metallic container body in one operation/step/location or multiple compounds applied to the inside of the metallic container body in multiple operations/steps/locations.

The corrosion inhibitor may be a one-part corrosion inhibitor applied during one operation. Alternatively, the corrosion inhibitor may be a two-part corrosion inhibitor with a first component (or first material) applied during a first operation and a second component (or second material) applied during a second operation of the container manufacturing process.

It is an aspect of embodiments of the present disclosure to apply a corrosion inhibitor to the interior surface of a container body at the container manufacturing facility. Thus, in some embodiments, the process of applying the corrosion inhibitor compound(s) may comprise using a spray (using water or another solvent as the base), steam, a powder, or another method to deliver the corrosion inhibitor to the interior surface of the container body. If the corrosion inhibitor is applied as a powder, i.e., using a puff of air to spread out the powder on the interior surface of the container body, then the powder needs to be hyperstatic to stick to the interior surface of the container bodies. Also note that while the Detailed Description describes the corrosion inhibitor as being sprayed onto the interior surface of the container body in some embodiments, the same steps and description apply if the corrosion inhibitor is a powder that is applied to the container body via a puff of air or using another gas.

In some embodiments, depending on where the corrosion inhibitor(s) are applied, the corrosion inhibitors may not need to be food contact safe. For example, if the corrosion inhibitor is applied in Area 1, Area 2 or Area 3 and the corrosion inhibitor is underneath the internal coating (such as is shown in FIG. 4B wherein the corrosion inhibitor is between the internal coating and an aluma layer), then the corrosion inhibitor will rarely contact the beverage and, therefore, does not need to be food contact safe. In other embodiments, such as when the corrosion inhibitor is applied in Area 4, Area 5 or Area 6, the corrosion inhibitor will contact the beverage and does need to be food contact safe.

Embodiments of the present disclosure have a number of advantages, including those listed above. Another advantage of embodiments of the present disclosure include being able to hold more corrosive/difficult liquids than can currently be held in prior art and current metallic container bodies. Some embodiments of the present disclosure also reduce the amount of internal coating needed/used (i.e., allows for a thinner layer of internal coating) by protecting the coating or aluminum side wall with the addition of the corrosion inhibitor. Currently, the only corrosion inhibitors used at some locations are conversion coatings that only improve corrosion resistance of the metal surface. Specifically, the interior surface of the container body is treated to provide a better adhesion of the internal coating. This is typically performed after the washer. Whereas the present disclosure improves corrosion resistance by not only using corrosion inhibitors that work on the container body's metal surface, but also corrosion inhibitors that improve the internal coating by adding an additional coating/layer or by filling voids in the internal coating.

Further example aspects of the present disclosure include: a first aspect that is a metallic container body comprising: (1) a container body having a cylindrical sidewall with an upper end and a lower end, the upper end defining an opening, and the lower end interconnected to a bottom portion forming a closed end, wherein the container body has an inner surface and an outer surface; (2) an internal coating positioned on at least a majority of the inner surface of the container body; and (3) a corrosion inhibitor positioned on at least a majority of the inner surface of the container body, wherein the internal coating or the corrosion inhibitor or both are applied directly onto the inner surface of the container.

Any of the aspects herein, where the metallic container body further comprises at least 50 picograms of corrosion inhibitor per square centimeter. Any of the aspects herein, where the metallic container body further comprises between about 50 picograms and about 500 mg of corrosion inhibitor. Any of the aspects herein, where the metallic container body further comprises between about 50 picograms and about 500 mg of corrosion inhibitor per square centimeter.

Any of the aspects herein, where the corrosion inhibitor is selected from the group consisting of polyphenols, terpenes, polysaccharides, vitamins, carboxylic acids, proteins, tannins, anthraquinones, amino acids, sterols, sugars, avonoids, and alkaloids. Examples of further specificity are also provided herein.

The metal container body of the first aspect, where the corrosion inhibitor comprises polyphenols.

The metal container body of the first aspect, where the corrosion inhibitor comprises terpenes.

The metal container body of the first aspect, where the corrosion inhibitor comprises polysaccharides.

The metal container body of the first aspect, where the corrosion inhibitor comprises vitamins.

The metal container body of the first aspect, where the corrosion inhibitor comprises carboxylic acids.

The metal container body of the first aspect, where the corrosion inhibitor comprises proteins.

The metal container body of the first aspect, where the corrosion inhibitor comprises tannins.

The metal container body of the first aspect, where the corrosion inhibitor comprises anthraquinones.

The metal container body of the first aspect, where the corrosion inhibitor comprises amino acids.

The metal container body of the first aspect, where the corrosion inhibitor comprises sterols.

The metal container body of the first aspect, where the corrosion inhibitor comprises sugars.

The metal container body of the first aspect, where the corrosion inhibitor comprises avonoids.

And the metal container body of the first aspect, where the corrosion inhibitor comprises alkaloids.

Any of the aspects herein, where the corrosion inhibitor is selected from the group consisting of compounds that contain phosphorus, nitrogen, sulfur, and oxygen atoms, and wherein the corrosion inhibitor has multiple bonds in its structure.

Any of the aspects herein, where the corrosion inhibitor is mixed with the internal coating and is applied to the inner surface of the container body in a heterogeneous layer.

Any of the aspects herein, where the corrosion inhibitor is positioned directly on the inner surface of the container body, and where the corrosion inhibitor is positioned between the internal coating and the inner surface of the container body.

Any of the aspects herein, where the internal coating is positioned directly on the inner surface of the container body, and where the internal coating is positioned between the corrosion inhibitor and the inner surface of the container body.

Further example aspects of the present disclosure include: a method of manufacturing a metallic container body, comprising: providing a metal coil; feeding the metal coil into a cupper; cutting circular blanks; forming the circular blanks into cups; pushing the cups through a series of tooling to redraw and iron the cups into container bodies; trimming an open end of the container bodies; washing the container bodies in a washer; applying a corrosion inhibitor onto an inner surface of the container bodies after the container bodies are washed; drying the container bodies after the corrosion inhibitor is applied; spraying an internal coating onto the corrosion inhibitor and the inner surface of the container bodies after drying the container bodies; forming a neck on the open end of the container bodies after the internal coating is sprayed onto the corrosion inhibitor; and putting completed container bodies onto pallets.

Any of the aspects herein, including the method provided above and elsewhere herein, where the corrosion inhibitor is selected from the group consisting of polyphenols, terpenes, polysaccharides, vitamins, carboxylic acids, proteins, tannins, anthraquinones, amino acids, sterols, sugars, avonoids, and alkaloids. Examples of further specificity are also provided herein.

The method above, where the corrosion inhibitor comprises polyphenols.

The method above, where the corrosion inhibitor comprises terpenes.

The method above, where the corrosion inhibitor comprises polysaccharides.

The method above, where the corrosion inhibitor comprises vitamins.

The method above, where the corrosion inhibitor comprises carboxylic acids.

The method above, where the corrosion inhibitor comprises proteins.

The method above, where the corrosion inhibitor comprises tannins.

The method above, where the corrosion inhibitor comprises anthraquinones.

The method above, where the corrosion inhibitor comprises amino acids.

The method above, where the corrosion inhibitor comprises sterols.

The method above, where the corrosion inhibitor comprises sugars.

The method above, where the corrosion inhibitor comprises avonoids.

The method above, where the corrosion inhibitor comprises alkaloids.

Further example aspects of the present disclosure include: a method of manufacturing a metallic container body, comprising: providing a metal coil; feeding the metal coil into a cupper; cutting circular blanks; forming the circular blanks into cups; pushing the cups through a series of tooling to redraw and iron the cups into container bodies; trimming an open end of the container bodies; washing the container bodies in a washer; drying the container bodies; applying a corrosion inhibitor onto an inner surface of the container bodies after drying the container bodies; spraying an internal coating onto the corrosion inhibitor and the inner surface of the container bodies; forming a neck on the open end of the container bodies after the internal coating is sprayed onto the corrosion inhibitor; and putting completed container bodies onto pallets.

Any of the aspects herein, including the method provided above and elsewhere herein, where the corrosion inhibitor is selected from the group consisting of polyphenols, terpenes, polysaccharides, vitamins, carboxylic acids, proteins, tannins, anthraquinones, amino acids, sterols, sugars, avonoids, and alkaloids. Examples of further specificity are also provided herein.

The method above, where the corrosion inhibitor comprises polyphenols.

The method above, where the corrosion inhibitor comprises terpenes.

The method above, where the corrosion inhibitor comprises polysaccharides.

The method above, where the corrosion inhibitor comprises vitamins.

The method above, where the corrosion inhibitor comprises carboxylic acids.

The method above, where the corrosion inhibitor comprises proteins.

The method above, where the corrosion inhibitor comprises tannins.

The method above, where the corrosion inhibitor comprises anthraquinones.

The method above, where the corrosion inhibitor comprises amino acids.

The method above, where the corrosion inhibitor comprises sterols.

The method above, where the corrosion inhibitor comprises sugars.

The method above, where the corrosion inhibitor comprises avonoids.

The method above, where the corrosion inhibitor comprises alkaloids.

Further example aspects of the present disclosure include: a method of manufacturing a metallic container body, comprising: providing a metal coil; feeding the metal coil into a cupper; cutting circular blanks; forming the circular blanks into cups; pushing the cups through a series of tooling to redraw and iron the cups into container bodies; trimming an open end of the container bodies; washing the container bodies in a washer; drying the container bodies; applying a corrosion inhibitor onto an inner surface of the container bodies after drying the container bodies; spraying an internal coating onto the corrosion inhibitor and the inner surface of the container bodies; curing the internal coating; forming a neck on the open end of the container bodies after curing the internal coating; and putting completed container bodies onto pallets.

Any of the aspects herein, including the method provided above and elsewhere herein, where the corrosion inhibitor is selected from the group consisting of polyphenols, terpenes, polysaccharides, vitamins, carboxylic acids, proteins, tannins, anthraquinones, amino acids, sterols, sugars, avonoids, and alkaloids. Examples of further specificity are also provided herein.

The method above, where the corrosion inhibitor comprises polyphenols.

The method above, where the corrosion inhibitor comprises terpenes.

The method above, where the corrosion inhibitor comprises polysaccharides.

The method above, where the corrosion inhibitor comprises vitamins.

The method above, where the corrosion inhibitor comprises carboxylic acids.

The method above, where the corrosion inhibitor comprises proteins.

The method above, where the corrosion inhibitor comprises tannins.

The method above, where the corrosion inhibitor comprises anthraquinones.

The method above, where the corrosion inhibitor comprises amino acids.

The method above, where the corrosion inhibitor comprises sterols.

The method above, where the corrosion inhibitor comprises sugars.

The method above, where the corrosion inhibitor comprises avonoids.

The method above, where the corrosion inhibitor comprises alkaloids.

Further example aspects of the present disclosure include: a method of manufacturing a metallic container body, comprising: providing a metal coil; feeding the metal coil into a cupper; cutting circular blanks; forming the circular blanks into cups; pushing the cups through a series of tooling to redraw and iron the cups into container bodies; trimming an open end of the container bodies; washing the container bodies in a washer; drying the container bodies; mixing a corrosion inhibitor into an internal coating to form a protective mixture; spraying the protective mixture onto an inner surface of the container bodies after the container bodies are dried; curing the protective mixture onto the inner surface; forming a neck on the open end of the container bodies after the protective mixture is cured; and putting completed container bodies onto pallets.

Any of the aspects herein, including the method provided above and elsewhere herein, where the corrosion inhibitor is selected from the group consisting of polyphenols, terpenes, polysaccharides, vitamins, carboxylic acids, proteins, tannins, anthraquinones, amino acids, sterols, sugars, avonoids, and alkaloids.

Further example aspects of the present disclosure include: a method of manufacturing a metallic container body, comprising: providing a metal coil; feeding the metal coil into a cupper; cutting circular blanks; forming the circular blanks into cups; pushing the cups through a series of tooling to redraw and iron the cups into container bodies; trimming an open end of the container bodies; washing the container bodies in a washer; drying the container bodies; spraying an internal coating onto an inner surface of the container bodies after drying the container bodies; applying a corrosion inhibitor onto the internal coating and the inner surface of the container bodies; curing the internal coating; forming a neck on the open end of the container bodies after the internal coating is cured; and putting completed container bodies onto pallets.

In some embodiments, the internal coating is cured before the corrosion inhibitor is applied onto the internal coating.

Alternatively, in other embodiments, the internal coating is cured after the corrosion inhibitor is applied onto the internal coating.

Any of the aspects herein, including the method provided above and elsewhere herein, where the corrosion inhibitor is selected from the group consisting of polyphenols, terpenes, polysaccharides, vitamins, carboxylic acids, proteins, tannins, anthraquinones, amino acids, sterols, sugars, avonoids, and alkaloids. Examples of further specificity are also provided herein.

The method above, where the corrosion inhibitor comprises polyphenols.

The method above, where the corrosion inhibitor comprises terpenes.

The method above, where the corrosion inhibitor comprises polysaccharides.

The method above, where the corrosion inhibitor comprises vitamins.

The method above, where the corrosion inhibitor comprises carboxylic acids.

The method above, where the corrosion inhibitor comprises proteins.

The method above, where the corrosion inhibitor comprises tannins.

The method above, where the corrosion inhibitor comprises anthraquinones.

The method above, where the corrosion inhibitor comprises amino acids.

The method above, where the corrosion inhibitor comprises sterols.

The method above, where the corrosion inhibitor comprises sugars.

The method above, where the corrosion inhibitor comprises avonoids.

The method above, where the corrosion inhibitor comprises alkaloids.

Further example aspects of the present disclosure include: a method of manufacturing a metallic container body, comprising: providing a metal coil; feeding the metal coil into a cupper; cutting circular blanks; forming the circular blanks into cups; pushing the cups through a series of tooling to redraw and iron the cups into container bodies; trimming an open end of the container bodies; washing the container bodies in a washer; drying the container bodies; spraying an internal coating onto an inner surface of the container bodies after drying the container bodies; curing the internal coating; applying a corrosion inhibitor onto the internal coating and the inner surface of the container bodies after curing the internal coating; forming a neck on the open end of the container bodies after applying the corrosion inhibitor; and putting completed container bodies onto pallets.

Any of the aspects herein, including the method provided above and elsewhere herein, where the corrosion inhibitor is selected from the group consisting of polyphenols, terpenes, polysaccharides, vitamins, carboxylic acids, proteins, tannins, anthraquinones, amino acids, sterols, sugars, avonoids, and alkaloids. Examples of further specificity are also provided herein.

The method above, where the corrosion inhibitor comprises polyphenols.

The method above, where the corrosion inhibitor comprises terpenes.

The method above, where the corrosion inhibitor comprises polysaccharides.

The method above, where the corrosion inhibitor comprises vitamins.

The method above, where the corrosion inhibitor comprises carboxylic acids.

The method above, where the corrosion inhibitor comprises proteins.

The method above, where the corrosion inhibitor comprises tannins.

The method above, where the corrosion inhibitor comprises anthraquinones.

The method above, where the corrosion inhibitor comprises amino acids.

The method above, where the corrosion inhibitor comprises sterols.

The method above, where the corrosion inhibitor comprises sugars.

The method above, where the corrosion inhibitor comprises avonoids.

The method above, where the corrosion inhibitor comprises alkaloids.

Further example aspects of the present disclosure include: a method of manufacturing a metallic container body, comprising: providing a metal coil; feeding the metal coil into a cupper; cutting circular blanks; forming the circular blanks into cups; pushing the cups through a series of tooling to redraw and iron the cups into container bodies; trimming an open end of the container bodies; washing the container bodies in a washer; drying the container bodies; spraying an internal coating onto an inner surface of the container bodies after drying the container bodies; forming a neck on the open end of the container bodies after spraying the internal coating onto the inner surface; applying a corrosion inhibitor onto the internal coating and the inner surface of the container bodies; and putting completed container bodies onto pallets.

Any of the aspects herein, including the method provided above and elsewhere herein, where the corrosion inhibitor is selected from the group consisting of polyphenols, terpenes, polysaccharides, vitamins, carboxylic acids, proteins, tannins, anthraquinones, amino acids, sterols, sugars, avonoids, and alkaloids. Examples of further specificity are also provided herein.

The method above, where the corrosion inhibitor comprises polyphenols.

The method above, where the corrosion inhibitor comprises terpenes.

The method above, where the corrosion inhibitor comprises polysaccharides.

The method above, where the corrosion inhibitor comprises vitamins.

The method above, where the corrosion inhibitor comprises carboxylic acids.

The method above, where the corrosion inhibitor comprises proteins.

The method above, where the corrosion inhibitor comprises tannins.

The method above, where the corrosion inhibitor comprises anthraquinones.

The method above, where the corrosion inhibitor comprises amino acids.

The method above, where the corrosion inhibitor comprises sterols.

The method above, where the corrosion inhibitor comprises sugars.

The method above, where the corrosion inhibitor comprises avonoids.

The method above, where the corrosion inhibitor comprises alkaloids.

Further example aspects of the present disclosure include: a method of manufacturing a container body for a metallic container in a production line, comprising: uncoiling a metallic sheet from a coil; feeding the metallic sheet into a cupper; cutting a circular blank from the metallic sheet in the cupper; forming the circular blank into a cup; pushing the cup through tooling of a bodymaker to redraw and iron the cup to form the container body; trimming, by a trimmer, an open end of the container body; washing the container body in a washer; drying the container body in a dry-off oven; applying, in an internal coater, an internal coating to an inner surface of the container body; curing the internal coating in an internal bake oven; forming, by a necker, a neck on the open end of the container body; placing, by a palletizer, the container body onto a pallet; and applying a first corrosion inhibitor to the inner surface of the container body at a first area of the production line.

Any of the aspects herein, including the method provided above and elsewhere herein, where the corrosion inhibitor is selected from the group consisting of polyphenols, terpenes, polysaccharides, vitamins, carboxylic acids, proteins, tannins, anthraquinones, amino acids, sterols, sugars, avonoids, and alkaloids. Examples of further specificity are also provided herein.

The method above, where the corrosion inhibitor comprises polyphenols.

The method above, where the corrosion inhibitor comprises terpenes.

The method above, where the corrosion inhibitor comprises polysaccharides.

The method above, where the corrosion inhibitor comprises vitamins.

The method above, where the corrosion inhibitor comprises carboxylic acids.

The method above, where the corrosion inhibitor comprises proteins.

The method above, where the corrosion inhibitor comprises tannins.

The method above, where the corrosion inhibitor comprises anthraquinones.

The method above, where the corrosion inhibitor comprises amino acids.

The method above, where the corrosion inhibitor comprises sterols.

The method above, where the corrosion inhibitor comprises sugars.

The method above, where the corrosion inhibitor comprises avonoids.

The method above, where the corrosion inhibitor comprises alkaloids.

Any of the aspects herein, including the method provided above and elsewhere herein, wherein the first area is one of: in the washer during the washing of the container body; after the container body leaves the washer and before the container body enters the dry-off oven; after the container body leaves the dry-off oven and before the container body enters the internal coater; after the container body enters the internal coater and before the container body enters the internal bake oven; after the container body leaves the internal bake oven and before the container body enters the necker; and after the container body leaves the necker and before the container body is placed onto the pallet.

Any of the aspects herein, including the method provided above and elsewhere herein, wherein the first corrosion inhibitor is selected from a first group consisting of polyphenols, terpenes, polysaccharides, vitamins, carboxylic acids, proteins, tannins, anthraquinones, amino acids, sterols, sugars, avonoids, and alkaloids.

Any of the aspects herein, including the method provided above and elsewhere herein, further comprising applying a second corrosion inhibitor to the inner surface of the container body at a second area of the production line, the second area being different from the first area.

Any of the aspects herein, including the method provided above and elsewhere herein, wherein the second corrosion inhibitor is selected from a second group consisting of polyphenols, terpenes, polysaccharides, vitamins, carboxylic acids, proteins, tannins, anthraquinones, amino acids, sterols, sugars, avonoids, and alkaloids.

Any of the aspects herein, including the method provided above and elsewhere herein, wherein the second corrosion inhibitor is the same as the first corrosion inhibitor.

Any of the aspects herein, including the method provided above and elsewhere herein, wherein the second corrosion inhibitor is different from the first corrosion inhibitor.

Any of the aspects herein, including the method provided above and elsewhere herein, wherein the first corrosion inhibitor and the second corrosion inhibitor are different from the internal coating.

Any of the aspects herein, including the method provided above and elsewhere herein, wherein the second area is one of: in the washer during the washing of the container body; after the container body leaves the washer and before the container body enters the dry-off oven; after the container body leaves the dry-off oven and before the container body enters the internal coater; after the container body enters the internal coater and before the container body enters the internal bake oven; after the container body leaves the internal bake oven and before the container body enters the necker; and after the container body leaves the necker and before the container body is placed onto the pallet.

Any of the aspects herein, including the method provided above and elsewhere herein, further comprising providing the coil, wherein the metallic sheet comprises an aluminum.

Any of the aspects herein, including the method provided above and elsewhere herein, wherein the first corrosion inhibitor is selected from a group consisting of compounds that contain phosphorus, nitrogen, sulfur, and oxygen atoms, and wherein the first corrosion inhibitor has multiple bonds in its structure.

Further example aspects of the present disclosure include: a system to manufacture a container body for a metallic container in a production line, comprising: an uncoiler to uncoil a metallic sheet from a coil; a cupper to receive the metallic sheet from the uncoiler, the cupper configured to cut a circular blank from the metallic sheet and form the circular blank into a cup; a bodymaker to redraw and iron the cup to form the container body; a trimmer to trim an open end of the container body, the trimmer being downstream from the bodymaker; a washer to wash the container body, the washer being downstream from the trimmer; a dry-off oven to dry the container body, the dry-off oven being downstream from the washer; an internal coater to apply an internal coating to an inner surface of the container body, the internal coater being downstream from the dry-off oven; an internal bake oven to cure the internal coating, the internal bake oven being downstream from the internal coater; a necker to form a neck on the open end of the container body, the necker being downstream from the internal bake oven; a palletizer to place the container body onto a pallet, the palletizer being downstream from the necker; and a first applicator to apply a first corrosion inhibitor to the inner surface of the container body, wherein the first applicator is positioned at a first area of the production line.

Any of the aspects herein, including the system provided above and elsewhere herein, where the corrosion inhibitor is selected from the group consisting of polyphenols, terpenes, polysaccharides, vitamins, carboxylic acids, proteins, tannins, anthraquinones, amino acids, sterols, sugars, avonoids, and alkaloids. Examples of further specificity are also provided herein.

The system above, where the corrosion inhibitor comprises polyphenols.

The system above, where the corrosion inhibitor comprises terpenes.

The system above, where the corrosion inhibitor comprises polysaccharides.

The system above, where the corrosion inhibitor comprises vitamins.

The system above, where the corrosion inhibitor comprises carboxylic acids.

The system above, where the corrosion inhibitor comprises proteins.

The system above, where the corrosion inhibitor comprises tannins.

The system above, where the corrosion inhibitor comprises anthraquinones.

The system above, where the corrosion inhibitor comprises amino acids.

The system above, where the corrosion inhibitor comprises sterols.

The system above, where the corrosion inhibitor comprises sugars.

The system above, where the corrosion inhibitor comprises avonoids.

The system above, where the corrosion inhibitor comprises alkaloids.

Any of the aspects herein, including the system provided above and elsewhere herein, wherein the first area is between an entrance to the washer and the palletizer

Any of the aspects herein, including the system provided above and elsewhere herein, wherein the first area is one of: in the washer; downstream from the washer and before the dry-off oven; downstream from the dry-off oven and before the internal coater; between an entrance to the internal coater and before the internal bake oven; downstream from the internal bake oven and before the necker; and downstream from the necker and before the palletizer.

Any of the aspects herein, including the system provided above and elsewhere herein, wherein the first area is between the entrance to the internal coater and before the internal bake oven, and wherein the first applicator is associated with the internal coater and is configured to apply a mixture of the internal coating and the first corrosion inhibitor to the inner surface of the container body.

Any of the aspects herein, including the system provided above and elsewhere herein, wherein the first area is between the entrance to the internal coater and before the internal bake oven, wherein the first applicator is associated with the internal coater, and wherein the internal coater is configured to apply a mixture of the corrosion inhibitor and the internal coating to the inner surface of the container body in a heterogeneous layer.

Any of the aspects herein, including the system provided above and elsewhere herein, wherein the first area is between the entrance to the internal coater and before the internal bake oven, and wherein the first applicator is associated with the internal coater and is configured to apply the first corrosion inhibitor to the inner surface of the container body before a sprayer of the internal coater applies the internal coating to the inner surface of the container body.

Any of the aspects herein, including the system provided above and elsewhere herein, wherein the first area is between an entrance to the internal coater and before the internal bake oven, and wherein the first applicator is associated with the internal coater and is configured to apply the first corrosion inhibitor to the inner surface of the container body after a sprayer of the internal coater applies the internal coating to the inner surface of the container body.

Any of the aspects herein, including the system provided above and elsewhere herein, wherein the first area is between an entrance to the internal coater and before the internal bake oven, and wherein the first applicator is associated with the internal coater and is configured to apply the first corrosion inhibitor to the inner surface of the container body approximately simultaneously with a sprayer of the internal coater that applies the internal coating to the inner surface of the container body.

Any of the aspects herein, including the system provided above and elsewhere herein, wherein the first corrosion inhibitor is selected from a first group consisting of polyphenols, terpenes, polysaccharides, vitamins, carboxylic acids, proteins, tannins, anthraquinones, amino acids, sterols, sugars, avonoids, and alkaloids.

Any of the aspects herein, including the system provided above and elsewhere herein, further comprising a second applicator to apply a second corrosion inhibitor to the inner surface of the container body, wherein the second applicator is positioned at a second area of the production line, the second area being different from the first area.

Any of the aspects herein, including the system provided above and elsewhere herein, wherein the second corrosion inhibitor is selected from a second group consisting of polyphenols, terpenes, polysaccharides, vitamins, carboxylic acids, proteins, tannins, anthraquinones, amino acids, sterols, sugars, avonoids, and alkaloids.

Any of the aspects herein, including the system provided above and elsewhere herein, wherein the first corrosion inhibitor and the second corrosion inhibitor are different from the internal coating, and wherein the second corrosion inhibitor is one of: the same as the first corrosion inhibitor; and different from the first corrosion inhibitor.

Any of the aspects herein, including the system provided above and elsewhere herein, wherein the second area is one of: in the washer; downstream from the washer and before the dry-off oven; downstream from the dry-off oven and before the internal coater; between an entrance to the internal coater and before the internal bake oven; downstream from the internal bake oven and before the necker; and downstream from the necker and before the palletizer.

Any of the aspects herein, including the system provided above and elsewhere herein, wherein the first corrosion inhibitor is selected from a group consisting of compounds that contain phosphorus, nitrogen, sulfur, and oxygen atoms, and wherein the first corrosion inhibitor has multiple bonds in its structure.

Any of the aspects herein, including the system provided above and elsewhere herein, wherein the first applicator is adapted to apply between about 50 picograms and about 500 mg of the first corrosion inhibitor to the inner surface.

Further example aspects of the present disclosure include: container body, comprising: a closed end; a sidewall extending from the closed end to an open end defining an opening, wherein the container body has an inner surface and an outer surface, and wherein the container body is formed of a metallic material; an internal coating positioned on at least a majority of the inner surface of the container body; and a corrosion inhibitor positioned on at least a majority of the inner surface of the container body.

Any of the aspects herein, including the container body provided above and elsewhere herein, further comprising between about 50 picograms and about 500 mg of the corrosion inhibitor.

Any of the aspects herein, including the container body provided above and elsewhere herein, wherein the corrosion inhibitor is mixed with the internal coating and is applied to the inner surface of the container body in a heterogeneous layer.

Any of the aspects herein, including the container body provided above and elsewhere herein, wherein the corrosion inhibitor is positioned directly on the inner surface of the container body such that the corrosion inhibitor is positioned between the internal coating and the inner surface of the container body.

Any of the aspects herein, including the container body provided above and elsewhere herein, wherein the internal coating is positioned directly on the inner surface of the container body such that the internal coating is positioned between the corrosion inhibitor and the inner surface of the container body.

Any of the aspects herein, including the container body provided above and elsewhere herein, wherein the corrosion inhibitor is selected from a group consisting of polyphenols, terpenes, polysaccharides, vitamins, carboxylic acids, proteins, tannins, anthraquinones, amino acids, sterols, sugars, avonoids, and alkaloids. Examples of further specificity are also provided herein.

The container body above, where the corrosion inhibitor comprises polyphenols.

The container body above, where the corrosion inhibitor comprises terpenes.

The container body above, where the corrosion inhibitor comprises polysaccharides.

The container body above, where the corrosion inhibitor comprises vitamins.

The container body above, where the corrosion inhibitor comprises carboxylic acids.

The container body above, where the corrosion inhibitor comprises proteins.

The container body above, where the corrosion inhibitor comprises tannins.

The container body above, where the corrosion inhibitor comprises anthraquinones.

The container body above, where the corrosion inhibitor comprises amino acids.

The container body above, where the corrosion inhibitor comprises sterols.

The container body above, where the corrosion inhibitor comprises sugars.

The container body above, where the corrosion inhibitor comprises avonoids.

The container body above, where the corrosion inhibitor comprises alkaloids.

Any of the aspects herein, including the container body provided above and elsewhere herein, wherein the corrosion inhibitor is selected from a group consisting of compounds that contain phosphorus, nitrogen, sulfur, and oxygen atoms, and wherein the corrosion inhibitor has multiple bonds in its structure.

For purposes of further disclosure, the following references generally related to corrosion inhibitors, preferably for metallic containers, are hereby incorporated by reference in their entireties: Rajesh K. Singh & Vikas Kumar, Aloe Vera used as Inhibitor for Corrosion Protection of Beverage Containing Stainless Steel, 14 GLOB. J. OF SCI. FRONTIER RES.: B CHEMISTRY 31, (2014); Camilia G. Dariva & Alexandre F. Galio, Corrosion Inhibitors—Principles, Mechanisms and Applications, in DEVELOPMENTS IN CORROSION PROTECTION (2014); M. A. Quarashi & Dheeraj Singh Chaugan, Drugs as Environmentally Sustainable Corrosion Inhibitors, Am. Chem. Soc'y 1 (2022); Klodian Xhanari et al., Green corrosion inhibitors for aluminium and its alloys: a review, 7 RSC ADV. 27299 (2017); M. A Hegazy et al., Effect of food grade organic compounds on corrosion of carbon steel in environmental corrosive media like as peracetic acid solution, 3 INT'L J. OF INNOVATIVE SCI., ENG'G & TECH. (2016); Klodian Xhanari & Matjaz Finsgar, Organic corrosion inhibitors for aluminum and its alloys in chloride and alkaline solutions: A review, ARABIAN J. OF CHEMISTRY, Aug. 17, 2016; and Gerard Ong et al., A review on plant extracts as natural additives in coating applications, 151 PROGRESS IN ORGANIC COATINGS 1 (2021).

The phrases “at least one,” “one or more,” “or,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, ratios, ranges, and so forth used in the specification and claims are to be understood as being modified in all instances by the term “about” or “approximately”. Accordingly, unless otherwise indicated, all numbers expressing quantities, dimensions, conditions, ratios, ranges, and so forth used in the specification and claims may be increased or decreased by approximately 5% to achieve satisfactory results. In addition, all ranges described herein may be reduced to any sub-range or portion of the range, or to any value within the range without deviating from the invention.

The term “a” or “an” entity, as used herein, refers to one or more of that entity. As such, the terms “a” (or “an”), “one or more” and “at least one” may be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof may be used interchangeably herein.

The terms “metal” or “metallic” as used hereinto refer to any metallic material that may be used to form a container, including without limitation aluminum, steel, tin, copper, and any combination thereof.

Although generally referred to herein as a “container body” or a “metallic container,” it should be appreciated that the methods and apparatus described herein may be used to apply a corrosion inhibitor to metal packaging and metallic containers of any size, shape, or type. Further, the methods and apparatus of the present disclosure may be used to apply a corrosion inhibitor to a container body (or a metallic container) formed by any method, including draw and wall ironing (DWI) methods and impact extrusion methods.

In some embodiments, a metallic container may include without limitation a metallic beverage bottle, a metallic beverage container or can, a container body, an aluminum bottle, a two-piece container, a two-piece can, a can, an aerosol container, a cylindrical food container, or a metal cup.

A container body generally includes a closed endwall, a sidewall, and an open end. In some embodiments, the sidewall may be generally cylindrical. However, other shapes of the sidewall are contemplated. For example, a metal cup may have a sidewall that has a diameter that increases from a first diameter near the closed end to a second diameter at the open end with the second diameter being greater than the first diameter.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description, Abstract, and Claims themselves.

These and other advantages will be apparent from this disclosure. The above-described embodiments, objectives, and configurations are neither complete nor exhaustive. The present disclosure is set forth in various levels of detail in the Summary as well as in the attached drawings and the Detailed Description and no limitation as to the scope of the present disclosure is intended by either the inclusion or non-inclusion of elements, components, etc. in this Summary Additional aspects of the present disclosure will become more clear from the Detailed Description, particularly when taken together with the drawings.

As will be appreciated, other embodiments are possible using, alone or in combination, one or more of the features set forth above or described below. Further, the Summary is neither intended nor should it be construed as representing the full extent and scope of the present disclosure. As will be appreciated, other embodiments are possible using, alone or in combination, one or more of the features set forth above or described below. For example, it is contemplated that various features and elements shown and/or described with respect to one embodiment or figure may be combined with or substituted for features or elements of other embodiments or figures regardless of whether or not such a combination or substitution is specifically shown or described herein.

Any one or more aspects described herein may be combined with any other one or more aspects described herein. Any one or more features described herein may be combined with any other one or more features described herein. Any one or more embodiments described herein may be combined with any other one or more embodiments described herein.

### BRIEF DESCRIPTION OF THE DRAWINGS

Those of skill in the art will recognize that the following description is merely illustrative of the principles of the invention, which may be applied in various ways to provide many different alternative embodiments. This description is made for illustrating the general principles of the teachings of this invention and is not meant to limit the inventive concepts disclosed herein.

The accompanying drawings, which are incorporated in and constitute a part of the specification, illustrate embodiments of the invention and together with the general description of the invention given above and the detailed description of the drawings given below, serve to explain the principles of the invention.

FIG. 1 is a schematic illustration of a typical container manufacturing process (i.e., metallic container body manufacturing process), in accordance with embodiments;

FIG. 2 shows a metallic container body manufacturing process and identifies the six possible locations or areas for adding the corrosion inhibitor during the manufacturing process, in accordance with embodiments;

FIG. 3 shows a flow chart of a container body manufacturing process with deviations for the addition of the corrosion inhibitor at Areas 1, 2, 4, and 5 of FIG. 2, in accordance with embodiments;

FIGS. 3A and 3B are enlarged portions of the flow chart in FIG. 3, in accordance with embodiments;

FIG. 4A is a perspective view of a metallic container body with a corrosion inhibitor applied before the internal coating such that the corrosion inhibitor is between the internal coating and the aluminum body, in accordance with embodiments;

FIG. 4B is a schematic cross-sectional view taken along line 4B-4B of FIG. 4A and illustrates an example of the layers of the metallic container body with the corrosion inhibitor applied before the internal coating such that the corrosion inhibitor is between the internal coating and the aluminum body, in accordance with embodiments;

FIG. 5 shows a flow chart with an example of manufacturing steps for a metallic container body with the corrosion inhibitor applied at Area 2 of FIG. 2, in accordance with embodiments;

FIG. 6A is a perspective view of a metallic container body with a corrosion inhibitor applied with the internal coating and before the internal coating is cured such that the corrosion inhibitor is fully or partially mixed with the internal coating, in accordance with embodiments;

FIG. 6B is a schematic cross-sectional view taken along line 6B-6B of FIG. 6A and illustrates an example of the layers of the metallic container body with the corrosion inhibitor applied with the internal coating and before the internal coating is cured such that the corrosion inhibitor is fully or partially mixed with the internal coating, in accordance with embodiments;

FIG. 7 shows a flow chart with an example of the manufacturing steps for a metallic container body with the corrosion inhibitor applied at Area 4 of FIG. 2, in accordance with embodiments;

FIG. 8A is a perspective view of a metallic container body with a corrosion inhibitor applied after the internal coating is applied and cured such that the corrosion inhibitor is positioned on top of the internal coating and the internal coating is between the corrosion inhibitor and the aluminum body, in accordance with embodiments;

FIG. 8B is a schematic cross-sectional view taken along line 8B-8B of FIG. 8A and showing an example of the layers of the metallic container body with the corrosion inhibitor applied after the internal coating is applied and cured such that the corrosion inhibitor is positioned on top of the internal coating and the internal coating is between the corrosion inhibitor and the aluminum body, in accordance with embodiments; and

FIG. 9 shows a flow chart with an example of the manufacturing steps for a metallic container body with the corrosion inhibitor applied at Area 5 or 6 of FIG. 2, in accordance with embodiments.

It should be understood that the drawings are not necessarily to scale, and various dimensions may be altered. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

To acquaint persons skilled in the pertinent arts most closely related to the present disclosure, a preferred embodiment that illustrates the best mode now contemplated for putting the invention into practice is described herein by, and with reference to, the annexed drawings that form a part of the specification. Exemplary embodiments are described in detail without attempting to describe all of the various forms and modifications in which the invention might be embodied. As such, the embodiments described herein are illustrative, and as will become apparent to those skilled in the arts, may be modified in numerous ways within the scope and spirit of the disclosure.

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

The use of “substantially” in the present disclosure, when referring to a measurable quantity (e.g., a diameter or other distance) and used for purposes of comparison, is intended to mean within 5% of the comparative quantity. The terms “substantially similar to,” “substantially the same as,” and “substantially equal to,” as used herein, should be interpreted as if explicitly reciting and encompassing the special case in which the items of comparison are “similar to,” “the same as” and “equal to,” respectively.

Note that while the Detailed Description describes the corrosion inhibitor as being sprayed onto the interior surface of the container body, the same steps and description apply if the corrosion inhibitor is a powder that is applied to the container body via a puff of air or using another gas.

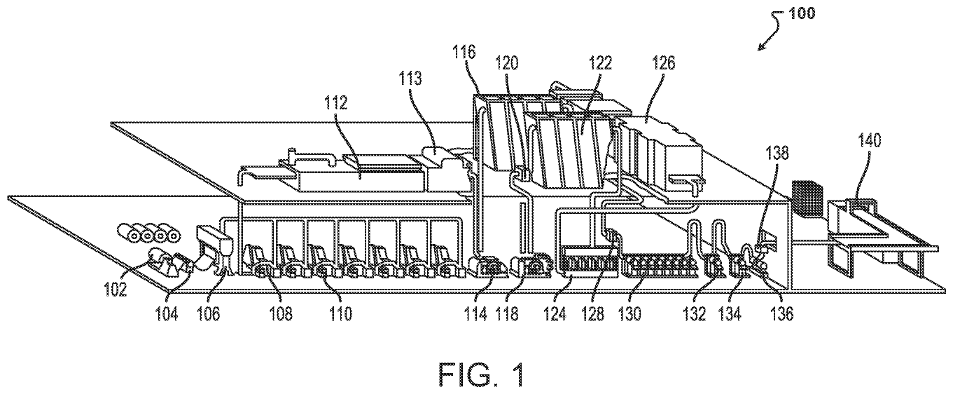

Referring now to FIG. 1, a container body manufacturing process 100 (i.e., metallic container body manufacturing process, or a metallic container production line) is generally shown with a number of steps or operations. In other embodiments, the manufacturing process may include fewer, more, or different steps or operations, or the operations may be performed in a different order. As will be appreciated by one of skill in the art, production lines 100 for metallic containers operate at high-speed. Some production lines may produce up to 2,000 container bodies per minute. Accordingly, equipment on the production line must work at high-speed. Further, modifications to the production line (such as to add new equipment to apply corrosion inhibitors) should not significantly reduce the speed or efficiency of the production line. Moreover, equipment on the production line must be capable of operating at high speeds with little down-time to prevent lost production time.

In particular, FIG. 1 illustrates an operation in which aluminum coils 102 are positioned on an uncoiler. In embodiments, an uncoiler unwinds the aluminum coil into a lubricator 104. The lubricator 104 applies a thin film of lubricant to the aluminum sheet and then feeds the metal sheet into a cupper 106. The cupper 106 cuts out circular blanks of aluminum and forms the blanks into cups.

Bodymakers 108 use a punch mounted on a ram to push the cups through a series of tooling dies that redraw and iron the cups into container bodies. Trimmers 110 trim the open end of the container bodies to a uniform height. A washer 112 washes and rinses the container bodies and a drier 113 dries the container bodies in preparation for the application of internal coatings and labels. The drier 113 is known as a dry-off oven if heat is used to dry the container bodies.

Optionally, basecoaters 114 are used if required by the design or decoration to be formed on the container bodies. Container bodies are conveyed to the basecoater 114 where a basecoat is applied to the outside of the container bodies as a base color for further printing. Optional, a basecoat oven 116 receives container bodies after receiving a basecoat. At the basecoat oven 116, the optional basecoat is cured onto the container bodies. A basecoater may not be used when the container body is formed into a metallic bottle.

Printers or container decorators 118 use up to six colors of ink to print labels or decorations on the container bodies. The decorator may also apply a thin film of lacquer over the label to protect it.

A bottom coater 120 applies a coat of lacquer to the rim around the bottom of container bodies to protect the aluminum. In some embodiments, such as when the production line 100 is used to produce metallic bottles, the bottom coater 120 may be positioned before the decorator 118.

A deco oven 122 (or “pin oven”) cures the inks and coatings on the container bodies. The container bodies are typically transported through the deco oven by pins extending from a chain.

An internal coater 124 sprays a thin layer of lacquer on the inside of the container bodies to protect product integrity. An internal coater oven 126 (also known as an internal bake oven or “IBO”) cures the internal coating.

A waxer 128 applies a thin coat of lubricant to the outside of the open edge of the open edge of the container bodies in preparation for necking. A waxer 128 may not be used when the container body is formed into a metallic bottle.

One or more die neckers 130 squeeze the openings of the container bodies down to end specifications. In some embodiments, the die neckers 130 may form a neck on the container bodies to create a metallic bottle. Additionally, when the production line 100 is used to produce metallic bottles, a thread is formed on the neck. In some embodiments, a station of a die necker 130 includes tooling to form the thread. In other embodiments, the thread is formed by tooling after the metallic bottles leaves the die necker 130. The thread is adapted to receive a roll-on pilfer proof closure.

In some embodiments, a flanger 132 optionally rolls back the top edge of the container body to form a lip used to attach an end closure to seal the container body after it is filled. In other embodiments, when the container bodies are formed into metallic bottles, the flanger 132 is not used.

A reprofile/reformer 134 may either reprofile the outer dome for of the closed ends of the container bodies for stackability or reform the inner dome for strength. A reprofile/reformer 134 is typically not used when forming metallic bottles.

A tester 136 checks all container bodies for possible pinholes or other damage. Additionally, or alternatively, a camera inspection system 138 checks for any contamination that might be in a container body.

In some embodiments, such as when the production line 100 is used to form metallic bottles, the production line includes a rinser to clean the metallic bottles after the necking and threading operations, and a drier or oven to dry the metallic bottles.

A palletizer 140 places finished container bodies on pallets, for example 389 container bodies per layer up to 21 layers high, for shipment or storage. After being shipped to customer, the container bodies are filled at high speeds. In some embodiments, end closures are attached, thereby forming a filled metallic container. In other embodiments, when the container bodies are metallic bottles, a ROPP closure is used to seal the container body after it is filled with a product.

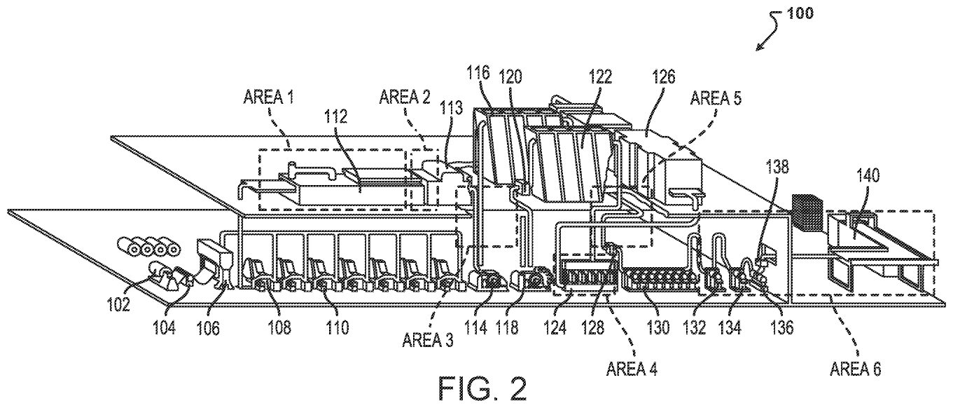

Referring now to FIG. 2, the metallic container body manufacturing process 100 as described in FIG. 1 is shown with the six possible locations (or areas) for adding the corrosion inhibitor during the manufacturing process. In some embodiments, the corrosion inhibitor is applied at Area 1: in the metallic container body washer 112. Area 1 is positioned after the lubricator 104, cupper 106, bodymakers 108, and trimmers 110 and before the dryer 113. Specifically, Area 1 is at the washer 112 before the oven/dryer 113. One advantage of applying the corrosion inhibitor at the washer 112 (Area 1) is that the equipment already has sprayers, which could spray the corrosion inhibitor onto the interior surface of the container body such that additional equipment is not needed or little additional equipment is needed.

Additionally, or alternatively, in some embodiments, the corrosion inhibitor is applied at Area 2: after the washer 112 but before the dryer 113. Thus, Area 2 is immediately after Area 1. It may be possible to use existing sprayers associated with the washer 112 to apply the corrosion inhibitor at Area 2. Alternatively, additional sprayers may need to be added between the washer 112 and dryer 113 in order to apply the corrosion inhibitor at Area 2.

A corrosion inhibitor that is applied at Area 1 or 2, must be able to maintain its integrity when going through the dryer, heated dryer, or dryer oven 113. Thus, the corrosion inhibitor must be able to withstand heat (for example, 60° C. or higher) when the dryer 113 is a heated dry-off oven. Additionally, or alternatively, the corrosion inhibitor applied at Area 1 or 2 must stick to the interior surface of the container body if the dryer 113 is blowing air into the container body to prevent the corrosion inhibitor from being blown out of the container, and to prevent unintended or inadvertent movement of the corrosion inhibitor due to the blowing air.

In some embodiments, a corrosion inhibitor is applied at Area 3: after the dryer 113. A corrosion inhibitor may be applied in Area 3 in addition to, or instead of, a corrosion inhibitor applied in Area 1 and/or Area 2. Area 3 is after Area 2 in the container body manufacturing process. Here, additional sprayers and/or other equipment are added to the production line to spray (or otherwise apply) the corrosion inhibitor into the container body or otherwise get the corrosion inhibitor into the container body. Area 3 is before the optional basecoat is applied by basecoaters 114 and before the basecoat ovens 116. Area 3 is also before the container decorators 118, bottom coater 120, and decorator oven 122.

A corrosion inhibitor applied at Area 1, 2, or 3, must be able to maintain its integrity when the container bodies go through the decorator oven 122. Thus, the corrosion inhibitor must be able to withstand heat (for example, 60° C. to 250° C.) and must stick to the interior surface of the container body if the oven 122 has fans that blow hot air onto the container body such as to not blow the corrosion inhibitor out of the container body, and to prevent unintended or inadvertent movement of the corrosion inhibitor due to the blowing air.

Areas 4 through 6 (i.e., locations 4 through 6) illustrate other possible locations for applying a corrosion inhibitor during the manufacturing process as shown in FIG. 2. In some embodiments, a corrosion inhibitor is applied at Area 4: during the application of the internal coating by an internal coater 124. Area 4 is after the decorator 118, bottom coater 120, and decorator oven 122, but before the internal coater oven 126.

Applying a corrosion inhibitor with the application of the internal coating can be done in several ways. In some embodiment, applying the corrosion inhibitor with the internal coating comprises spraying the corrosion inhibitor onto the interior surface of the container body before applying the internal coating.

Additionally, or alternatively, in some embodiments the corrosion inhibitor is mixed with the internal coating. The mixture of corrosion inhibitor and internal coating may then be sprayed onto the interior surface of the container body.

In still other embodiments, the corrosion inhibitor is applied (or sprayed) onto the interior surface of the container body after the internal coating has been sprayed onto the interior surface of the container body but before the internal coating is cured.

If a corrosion inhibitor is applied at Area 4, then additional equipment may be added to the internal coater 124 and/or the internal coater may be modified. For example, an extra line to bring in the corrosion inhibitor may be required, a mixing container to mix the corrosion inhibitor with the internal coating may be needed, and/or extra sprayers may be needed to spray the corrosion inhibitor onto the interior surface of the container body before or after the internal coating is applied.

A corrosion inhibitor applied at Area 4 must be able to maintain its integrity when going through the internal coater oven 126 which cures the internal coating. Thus, a corrosion inhibitor applied at Area 4 must be able to withstand heat (for example, 60° C. to 250° C. in the internal coater oven 126 depending on the temperature needed to cure the internal coating).

Additionally, or alternatively, in some embodiments, a corrosion inhibitor is applied at Area 5: after the application and curing of the internal coating but before necking operations performed by the die necker 130. Specifically, Area 5 is after the internal coater oven 126, because the internal coating needs to be cured, and is before the waxer 128, or is before the die necker 130. At this point in the manufacturing process, the metallic container body (e.g., can) is done with all heating steps, meaning the container body will not be subjected to high temperatures after the internal coater oven 126. Thus, any corrosion inhibitor added to the container body at Area 5 does not need to withstand high temperatures (e.g., over 60° C.) and, therefore, more delicate corrosion inhibitors may be used. As such, the number of possible corrosion inhibitors that could be added at Area 5 or 6 is larger than the number of possible corrosion inhibitors that could be added at Areas 1, 2, 3, and 4.

If a corrosion inhibitor is added at Area 5, then additional equipment will be needed to bring in the corrosion inhibitor and apply it onto the interior surface of the container bodies. In some embodiments, a sprayer may be added to the production line 100 in Area 5 to spray the corrosion inhibitor.

In some embodiments, a corrosion inhibitor is applied at Area 6: after necking operations performed by the necker 130 but before the palletizer 140. A corrosion inhibitor may be applied at Area 6 in addition to, or instead of, a corrosion inhibitor applied to the container bodies at one or more of Area 1, Area 2, Area 3, Area 4, and Area 5. Area 6 is after the die necker 130 and before the palletizer 140. Here, the corrosion inhibitor may be applied to the container before the flanger 132, after the flanger and before the reprofile/reformer 134, after the reprofile/reformer and before the tester 136 and camera 138, or after the camera 138 and before the palletizer 140.

The corrosion inhibitor may be applied to the inside of the container body after necking operations by spraying a mist into the container body or spraying a powder into the container body. Because the neck of the container is formed at this point, spraying a liquid or powder from below the container body may not evenly coat the entire interior surface of the container body. Therefore, in one embodiment, a wand or probe may be used to apply the corrosion inhibitor. In at least some embodiments, the wand is adapted to be inserted into the container body such that the corrosion inhibitor is sprayed into the container body. In some embodiments, the wand is configured to spray the corrosion inhibitor onto the cylindrical sidewall and top edge of the container body (for example, between the neck portion to the top edge. In some embodiments, the wand is adapted such that it does not apply the corrosion inhibitor to the neck portion. The wand may have multiple nozzles to spray the corrosion inhibitor in multiple directions and coat the interior surface of the container body substantially evenly.

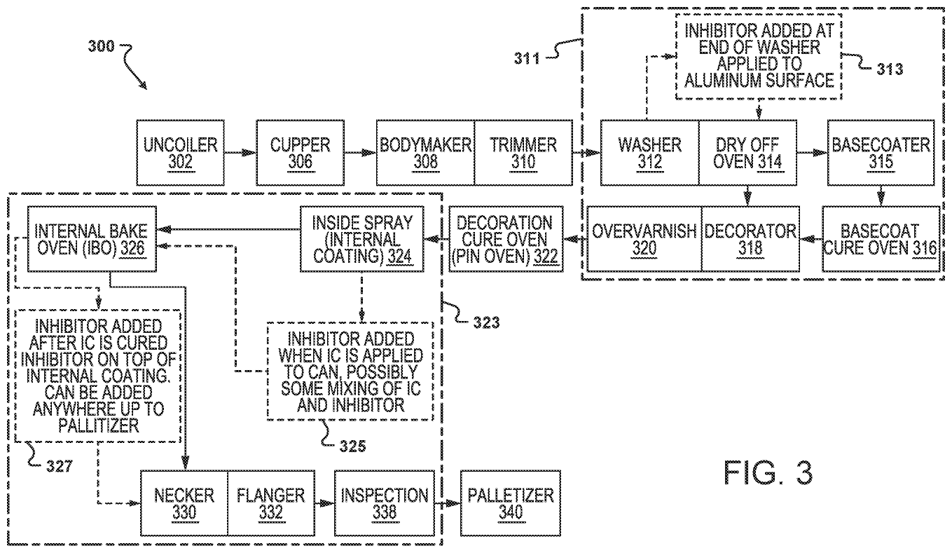

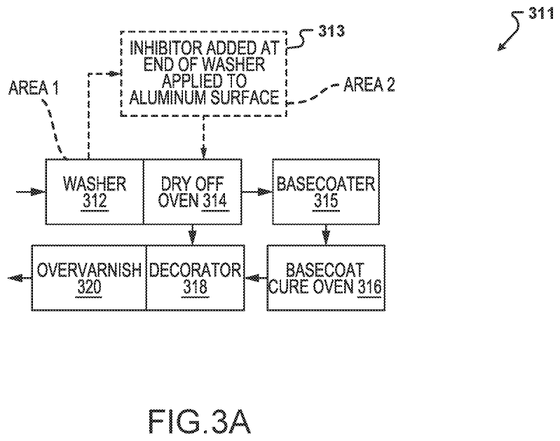

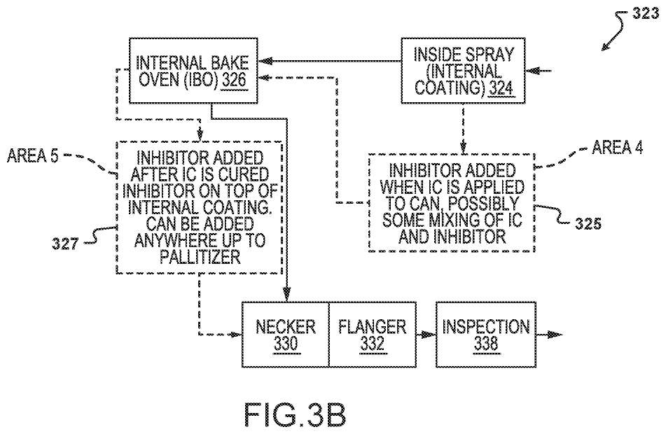

FIG. 3 shows a flow chart of a metallic container body manufacturing process 300 with deviations for the addition of a corrosion inhibitor at one or more of Areas 1, 2, 4, and 5. Enlarged portions of FIG. 3 are shown in FIGS. 3A and 3B. Specifically, FIG. 3A shows the part of the process where the corrosion inhibitor is added at one or more of Area 1 and Area 2. FIG. 3B shows the part of the process where the corrosion inhibitor is added at one or more of Area 4 and Area 5. The components of process 300 (and its associated production line) are the same as or similar to the components described in FIGS. 1-2 in conjunction with process 100.

As seen in FIG. 3, in some embodiments, the process 300 (or production line) for manufacturing a container body begins at an uncoiler 302. The process continues at a cupper 306. Additionally, the process moves to a bodymaker 308 and trimmer 310. The process then progresses to a washer 312 and a dryer or dry off oven 314.

In some embodiments, the process 300 then moves to a decorator 318 and an overvarnish applicator 320. Alternatively, in some embodiments, the process alternates by proceeding from the dryer 314 to a basecoater 315 and then a basecoat cure oven 316 prior to the decorator 318 and overvarnish applicator 320. Further, specific portions of the process are discussed within a first process cutout 311 and discussed further in FIG. 3A.

After the decorator 318 and the overvarnish applicator 320, the process moves to a decoration cure oven (or pin oven) 322. Next, the process moves to an internal coater (or internal spray applicator) 324. The process then moves to an internal bake oven (IBO) 326. After the IBO, the process 300 continues to a necker 330.

In some embodiments, after the necker 330 the process continues to a flanger 332. Alternatively, when the container body is a metallic bottle, the process may continue to a threader (not illustrated), or a thread may be formed by the necker.

Next, the process moves to an inspection system 338. The process next moves to a palletizer 340. Further, specific portions of the process are discussed within a second process cutout 323 and discussed further in FIG. 3B.

As seen in FIG. 3, there are also three further operations 313, 325, 327 for providing a corrosion inhibitor.

Referring to FIG. 3A, in some embodiments, a corrosion inhibitor is applied to a container body while the container body is in the washer 312. This is Area 1.

Additionally, or alternatively, and as seen at operation 313, in some embodiments a corrosion inhibitor is added after the washer 312 and is applied to an aluminum surface before the container bodies move to a dryer 314. This is Area 2.

Referring now to FIG. 3B, as seen at operation 325, additionally or alternatively, a corrosion inhibitor may optionally be added when the internal coating is applied to the container body by the internal coater 324. This is Area 4.

In some embodiments, there is mixing of the internal coating and the corrosion inhibitor before the internal coater 324 applies the internal coating and corrosion inhibitor to the container bodies. Accordingly, an applicator of the internal coater 324 may apply a mixture of the internal coating and the corrosion inhibitor to the container bodies.

Alternatively, the internal coating may be applied from two or more different applicators of the internal coater 324 than are used to apply the internal coating. Specifically, a first applicator of the internal coater 324 may apply an internal coating and a second applicator of the internal coater may apply a corrosion inhibitor. In these embodiments, the internal coating and the corrosion inhibitor may mix together after being applied to the container bodies.

As also seen at operation 327, in some other embodiments, a corrosion inhibitor is added after the internal coating is cured by the internal bake oven 326 with the inhibitor added on top of the internal coating. This is Area 5.

As will be appreciated, in alternative embodiments, a corrosion inhibitor may be added in one or more locations or operations prior to the palletizer 340.

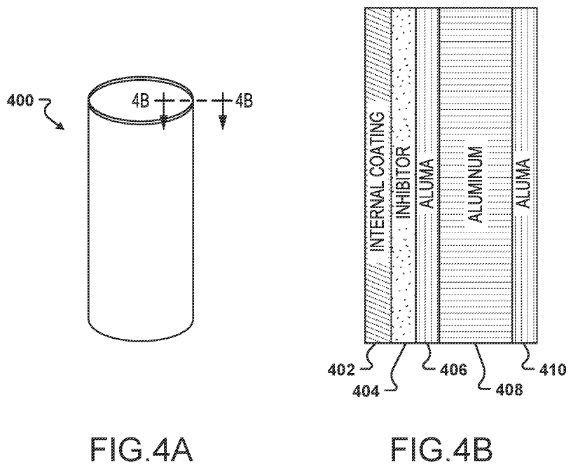

Referring now to FIGS. 4A and 4B, examples of a container body 400 and a cross-sectional schematic illustration of the layers of the metallic container body 400 are shown. The container body 400 includes a corrosion inhibitor 404 which was applied at Area 1, Area 2, or Area 3, i.e., before the internal coating 402 is applied. Accordingly, the corrosion inhibitor 404 is between the internal coating 402 and the aluminum body (layers 406, 408, 410).

As seen in FIG. 4A, a container body 400 is illustrated with layers as oriented in FIG. 4B. As seen in FIG. 4B, the layers include an internal coating layer 402, a corrosion inhibitor layer 404, an first aluma layer 406, an aluminum layer 408, and a second aluma layer 410. The internal coating layer 402 is the innermost layer and will be in contact with a product stored in the container body 400.

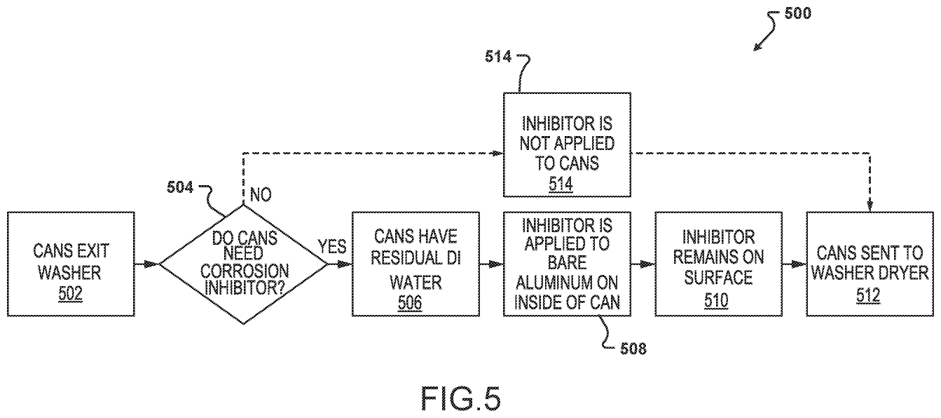

FIG. 5 shows an example of a process 500 of manufacturing operations for a metallic container body with the corrosion inhibitor applied at Area 2, i.e., before the container body is sent to a dryer 113, 314 and before an internal coating is applied. Accordingly, the corrosion inhibitor is between the internal coating and the aluminum body as generally illustrated in FIG. 4B.

As seen in FIG. 5, at step 502 container bodies exit a washer 112, 312. At step 504, a decision is made as to whether container bodies need a corrosion inhibitor. In some embodiments, container bodies entering process 500 may not yet have a corrosion inhibitor. In some embodiments, container bodies entering process 500 may already have a first corrosion inhibitor applied. Accordingly, in some embodiments, at step 504 the decision is made as to whether container bodies need a further corrosion inhibitor.

In embodiments where a decision at step 504 is determined to be “yes,” process 500 moves forward to step 506 where container bodies have residual deionized water. At step 508, an inhibitor is applied to bare aluminum on the inside of a container body. At step 510, an inhibitor remains on a surface. Finally, at step 512, container bodies are sent to a dryer 113, 314.

In embodiments where a decision at step 504 is determined to be “no,” process 500 moves forward to step 514, and a corrosion inhibitor is not applied to the container bodies in process 500. From step 514, the process 500 moves to step 512 where the container bodies are sent to the dryer 113, 314.

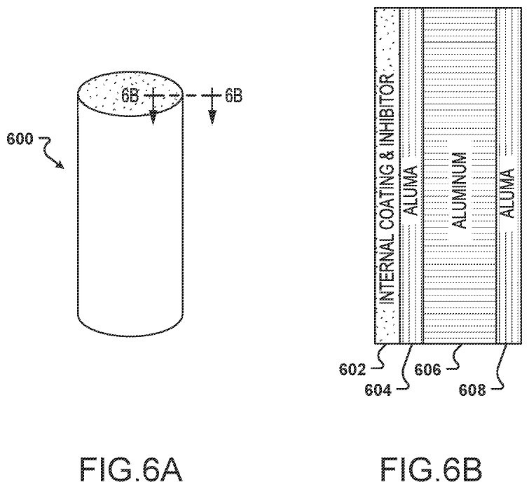

Referring now to FIG. 6A, a container body 600 according to embodiments of the present disclosure is schematically illustrated. The container body 600 has a corrosion inhibitor which was applied at Area 4, i.e., applied with the internal coating and before the internal coating is cured such that the corrosion inhibitor is fully or partially mixed with the internal coating.

FIG. 6B is a cross-sectional schematic illustration showing the layers of the metallic container body 600. As seen in FIG. 6B, the layers include a layer 602 of an internal coating mixed with a corrosion inhibitor, a first aluma layer 604, an aluminum layer 606, and a second aluma layer 608. The combined internal coating and corrosion inhibitor layer 602 is the innermost layer and will be in contact with a product stored in the container body 600.

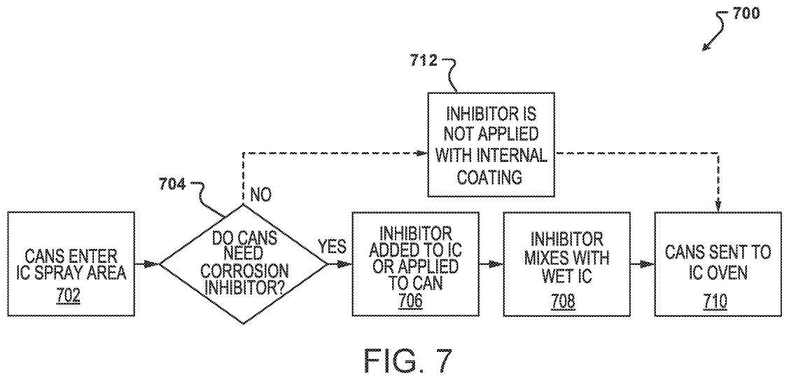

FIG. 7 illustrates an example of a process 700 of manufacturing a metallic container body with the corrosion inhibitor applied at Area 4. More specifically, in process 700, a corrosion inhibitor is optionally applied with the internal coating by the internal coater 124, 324 and before the internal coating is cured such that the corrosion inhibitor is fully or partially mixed with the internal coating. The corrosion inhibitor may be applied before the internal coating, after the internal coating but before the internal coating is cured, or the corrosion inhibitor may be mixed in with the internal coating.

As seen in FIG. 7, at step 702 container bodies enter a spray area of an internal coater 124, 324. At step 704, a decision is made as to whether the container bodies need a corrosion inhibitor. In some embodiments, container bodies entering process 700 may not yet have a corrosion inhibitor. In some embodiments, container bodies entering process 700 may already have a first corrosion inhibitor applied (or multiple corrosion inhibitors previously applied). Accordingly, in some embodiments, at step 704 the decision is made as to whether container bodies need a further corrosion inhibitor.

In embodiments where a decision at step 704 is determined to be “yes,” process 700 moves forward to step 706 where a corrosion inhibitor is applied to an internal coating or applied to the container body. At step 708, the corrosion inhibitor mixes with a wet internal coating. Finally, at step 710, the container bodies are sent to an internal coater oven 126, 326. As previously discussed, an example of the layers of the container body 600 with a corrosion inhibitor applied according to step 706 is generally illustrated in FIG. 6B.

In embodiments where a decision at step 704 is determined to be “no,” process 700 moves forward to step 712, and a corrosion inhibitor is not applied to the container bodies in process 700. From step 712, the process 700 moves to step 710 where the container bodies are sent to the internal coater oven 126, 326.

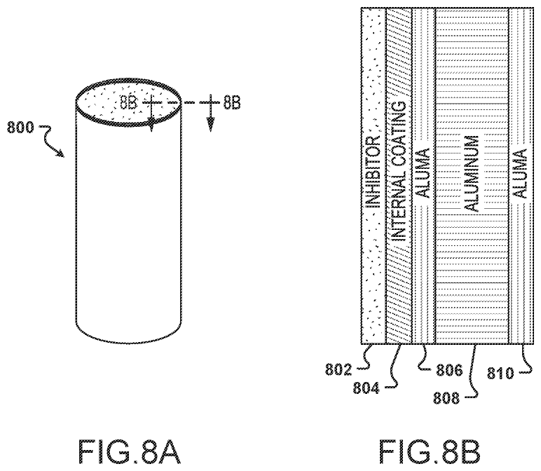

Referring now to FIG. 8A, a container body 800 according to embodiments of the present disclosure is schematically illustrated. The container body 800 has a corrosion inhibitor which was applied at Area 5 or Area 6, i.e., after the internal coating is applied and cured such that the corrosion inhibitor is positioned on top of the internal coating and the internal coating is between the corrosion inhibitor and the aluminum container.

FIG. 8B is a cross-sectional schematic illustration showing the layers of the metallic container body 800. As seen in FIG. 8B, the layers include a corrosion inhibitor 802, an internal coating 804, a first aluma layer 806, an aluminum layer 808, and a second aluma layer 810. Accordingly, the internal coating 804 is positioned between the corrosion inhibitor 802 and the material of the container body (the aluma layers 806, 810 and the aluminum layer 808). Further, the layer 802 of the corrosion inhibitor is the innermost layer and will be in contact with a product stored in the container body 800. Accordingly, corrosion inhibitors that are not safe for contact with foods may not be applied in Area 5 or Area 6.

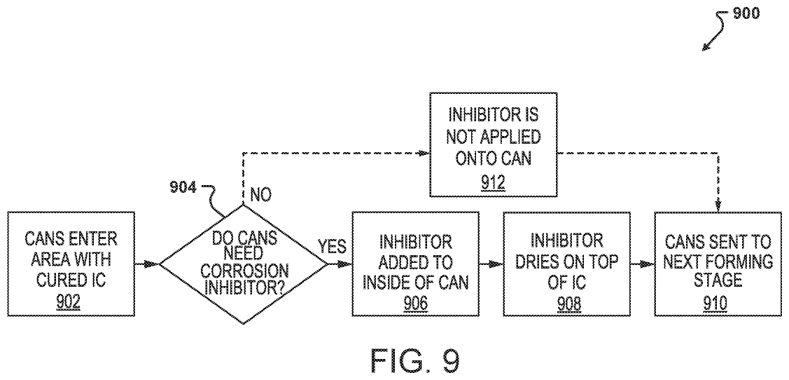

FIG. 9 shows an example of a process 900 of manufacturing a metallic container body with the corrosion inhibitor applied at Area 5 or Area 6. More specifically, in process 900, a corrosion inhibitor is optionally applied after the internal coating is applied and cured such that the corrosion inhibitor is positioned on top of the internal coating and the internal coating is between the corrosion inhibitor and the aluminum container as generally illustrated in FIG. 8B.

As seen in FIG. 9, at step 902 container bodies enter an area with a cured internal coating. At step 904, a decision is made as to whether the container bodies need a corrosion inhibitor. In some embodiments, container bodies entering process 900 may not yet have a corrosion inhibitor. In some embodiments, container bodies entering process 900 may already have a first corrosion inhibitor applied (or multiple corrosion inhibitors previously applied). Accordingly, in some embodiments, at step 904 the decision is made as to whether container bodies need a further corrosion inhibitor.

In embodiments where a decision at step 904 is determined to be “yes,” process 900 moves forward to step 906 where a corrosion inhibitor is added to the inside of a container body. At step 908, the corrosion inhibitor dries on top of the internal coating of the container body. Finally, at step 910, container bodies are sent to the next forming stage of the contain body manufacturing process.

In embodiments where a decision at step 904 is determined to be “no,” process 900 moves forward to step 912, and a corrosion inhibitor is not applied to the container bodies in process 900. From step 912, the process 900 moves to step 910 where container bodies are sent to a next forming stage.

In some embodiments, one or more corrosion inhibitors are applied to the interior surface of container body at Area 1, another corrosion inhibitor (which may be the same as or different than the first corrosion inhibitor) is applied to the interior surface of container body at Area 2, another corrosion inhibitor (which may be the same as or different than the first or second corrosion inhibitor) is applied to the interior surface of container body at Area 3, another corrosion inhibitor (which may be the same as or different than the first, second, or third corrosion inhibitor) is applied to the interior surface of container body at Area 4, another corrosion inhibitor (which may be the same as or different than the first, second, third, or fourth corrosion inhibitor) is applied to the interior surface of container body at Area 5, and/or another corrosion inhibitor (which may be the same as or different than the first, second, third, fourth, or fifth corrosion inhibitor) is applied to the interior surface of container body at Area 6, and any combination thereof. Meaning one corrosion inhibitor could be applied at Area 1, a different corrosion inhibitor could be applied at Area 3, and the same corrosion inhibitor used at Area 1 could be applied at Area 6, for example.

While multiple types of corrosion inhibitors may be used in embodiments discussed herein, there are particular corrosion inhibitors that contain characteristics that are able to be tailored for particular parts of a container body manufacturing process. In particular, in some embodiments across the proposed six areas, Area 1 through Area 6, where certain corrosion inhibitors are expected to work better than others. Likewise, in some embodiments across the proposed six areas, some corrosion inhibitors may be unideal for use if, for example, further processing steps may reduce or eliminate the benefits of adding the corrosion inhibitor. For example, in embodiments where a particular corrosion inhibitor is sensitive to heat, it may be unideal to apply that particular corrosion inhibitor ahead of processing step that applies heat or a heat treatment to the container body.

In some embodiments, a choice of corrosion inhibitor may also be based on an efficiency of updating and maintaining a manufacturing process to add the particular corrosion inhibitor. Likewise, a placement of a corrosion inhibitor process across a manufacturing process may be impacted by what location is easiest to build and maintain as a new process step within the manufacturing process.

In some embodiments, a choice of corrosion inhibitor may also be based on an efficiency of cost to add the particular corrosion inhibitor. Likewise, a placement of a corrosion inhibitor process across a manufacturing process may be impacted by what location is the cheapest to build and maintain as a new process step within the manufacturing process.

In some embodiments, one corrosion inhibitor may be added to a container body manufacturing process. In some embodiments, two corrosion inhibitors may be added to a container body manufacturing process. In some embodiments where two corrosion inhibitors are added to a container body manufacturing process, each of the two corrosion inhibitors may be added at separate steps of the container body manufacturing process. In some embodiments where two corrosion inhibitors are added to a container body manufacturing process, each of the two corrosion inhibitors may be added at a same step, or at nearly a same step, of the container body manufacturing process. In some embodiments where two corrosion inhibitors are added to a container body manufacturing process, the two corrosion inhibitors may be mixed together and added at the same steps of the container body manufacturing process.

### One-Part Corrosion Inhibitor

In some embodiments, the corrosion inhibitor is a one-part corrosion inhibitor. The one-part corrosion inhibitor may be applied at various operations of the container body manufacturing processes described herein. The one-part corrosion inhibitor generally comprises a material which has a large molecule. The material must be food safe, must not impact flavor and should be relatively inexpensive. The material fills in any pores or gaps in the internal coating to prevent or slow down the rate at which a liquid corrodes metallic material of the container body.

One or more other materials may be added to (or applied with) the one-part corrosion inhibitor to improve one or more of the drying, curing, and absorption of the one-part corrosion inhibitor.

In some embodiments, a solvent is added to (or applied with) the one-part corrosion inhibitor. In some embodiments, the solvent is a liquid. The solvent may cause the internal coating to become softer (more porous) and allow the one-part corrosion inhibitor to be absorbed more quickly into the internal coating.

Any suitable solvent known to those of skill in the art may be used. In some embodiments, the solvent comprises one or more of: a solvents that contain OH groups such as methanol, ethanol, propanol, isopropanol, butanol, and the like; 2-butoxyethanol; and other similar solvents known to those of skill in the art of metal packaging. Other suitable solvents include low molecular weight hydrocarbons such as butane, heptane, and hexane which could be volatized and evaporated from the container body.

Additionally, or alternatively, heat and/or energy may be applied to the one-part corrosion inhibitor. For example, the surface temperature of the container body may be raised to increase the speed of movement of the one-part corrosion inhibitor into the internal coating.

In some embodiments, light may be applied to the corrosion inhibitor to increase reaction rates of the one-part corrosion inhibitor. The light may be of any suitable wavelength. For example, the light may comprise visible light and/or UV light.

Optionally, vibrations may be used to improve performance of the corrosion inhibitor. For example, the container body may be exposed to ultrasonic waves to increase movement of the one-part corrosion inhibitor into the internal coating. The vibrations may also be used to improve dispersion of the one-part corrosion inhibitor.

In still other embodiments, an electrochemical process may be used to improve performance of the corrosion inhibitor. For example, a charge (negative or positive) may be applied to a metallic surface of the container body to cause the one-part corrosion inhibitor to be attracted to the metallic surface. In some embodiments, the one-part corrosion inhibitor can be introduced as an aerosol or dissolved in a liquid.

The one-part corrosion inhibitor may be applied in the manufacturing process in several different operations according to various embodiments of the present disclosure.

Applying a One-Part Corrosion Inhibitor when Manufacturing a Metallic Bottle

In some embodiments, such as to manufacture a container body that is formed into a metallic bottle, the container body is formed from a metal sheet as described herein. An internal coating is applied to an interior surface of the container body by an internal coater 124 and the internal coating is subsequently cured in an internal bake oven 126. The container body is then necked in a necker 130. A thread is then formed on the neck. After the thread is formed, the one-part corrosion inhibitor is applied to the interior surface which already includes the internal coating. After the necking and the threading, the container body may be rinsed and subsequently dried in a final drier (or final dry-off oven).

In some embodiments, the one-part corrosion inhibitor is applied to the interior surface before the threaded container body is rinsed. Alternatively, in other embodiments, the one-part corrosion inhibitor is applied after the threaded container body is rinsed but before the final drying in the drier.

The one-part corrosion inhibitor may be applied to the interior surface of the container body using any suitable method by any appropriate equipment known to those of skill in the art. In some embodiments, the one-part corrosion inhibitor is sprayed onto the interior surface by a sprayer.

Applying a One-Part Corrosion Inhibitor when Manufacturing a Container Body or a Metallic Cup

In some embodiments, one-part corrosion inhibitor may be applied according to a method used to manufacture a container body or a metallic cup (collectively referred to as a workpiece). The workpiece is formed by a bodymaker 108 as described herein. After the bodymaker 108, one or more subsequent operations are performed on the workpiece. The workpiece is then conveyed to an internal coater 124 which applies an internal coating to an interior surface of the workpiece. The internal coating is subsequently cured in an internal bake oven 126. Further operations are subsequently performed to form the workpiece into either the container body or the metallic cup. After all metal forming operations are completed, a one-part corrosion inhibitor is applied to the interior coating already on the container body or the metallic cup.

In some embodiments, the container body or metallic cup is transported through an area to permit the one-part corrosion inhibitor to at least partially penetrate the internal coating and/or to dry the corrosion inhibitor. The area may comprise fans or blowers. Additionally, or alternatively, the area may comprise a heater or oven.

A First Method of Applying a One-Part Corrosion Inhibitor when Manufacturing a Container Body, a Metallic Cup, or a Metallic Bottle

In other embodiments, the one-part corrosion inhibitor may be applied according to a first method used to manufacture a container body, a metallic cup, or a metallic bottle (collectively referred to as a workpiece). The workpiece is formed by a bodymaker 108, trimmed by a trimmer 110, and washed by a washer 112 as described herein. After the washer 112 and before the dryer 113 (i.e., Area 2), the one-part corrosion inhibitor is applied to the interior surface of the workpiece. The workpiece with the corrosion inhibitor is then transported through the dryer 113 and one or more subsequent operations are performed. The workpiece then receives an internal coating from an internal coater 124 which is cured by an internal bake oven 126. The one-part corrosion inhibitor will be exposed in areas that did not receive the internal coating (or which were not adequately covered by the internal coating). Additionally, or alternatively, in some embodiments, the one-part corrosion inhibitor will migrate through the internal coating to areas of low, inadequate, or no coverage by the internal coating.

Thereafter, the workpiece is transported to subsequent equipment where one or more operations are performed to form the workpiece into one of a container body, a metallic cup, or a metallic bottle.

A Second Method of Applying a One-Part Corrosion Inhibitor when Manufacturing a Container Body, a Metallic Cup, or a Metallic Bottle

In still other embodiments, the one-part corrosion inhibitor may be applied according to a second method used to manufacture a container body, a metallic cup, or a metallic bottle (collectively referred to as a workpiece). The workpiece is formed by a bodymaker 108 as described herein. The workpiece is then transported to equipment which performs one or more subsequent operations.

The workpiece is subsequently transported to an internal coater 124. The one-part corrosion inhibitor is applied to an interior surface of the workpiece when the internal coater 124 applies an internal coating to the interior surface (i.e., at Area 4). As described herein, in some embodiments, the internal coater 124 may apply the one-part corrosion inhibitor approximately simultaneously with the internal coating. For example, the one-part corrosion inhibitor may be mixed with the corrosion inhibitor, and the mixture applied to the interior surface by a nozzle or sprayer of the internal coater. Alternatively, the one-part corrosion inhibitor may be applied by a first applicator of the internal coater before the internal coating is applied by a second applicator. In still other embodiments, the one-part corrosion inhibitor may be applied by a first applicator of the internal coater while the internal coating is applied by a second applicator. In yet another embodiment, the internal coating is applied by a first applicator of the internal coater before the one-part corrosion inhibitor is applied by a second applicator.

After the internal coater 124 applies the one-part corrosion inhibitor and the internal coating to the interior surface, the workpiece is transported through an internal bake oven 126 to cure the one-part corrosion inhibitor and the internal coating. Thereafter, the workpiece is transported to subsequent equipment where one or more operations are performed to form the workpiece into one of a container body, a metallic cup, or a metallic bottle.

### Two-Part Corrosion Inhibitor

In some embodiments, the corrosion inhibitor is a two-part corrosion inhibitor. The two-part corrosion inhibitor may be applied during two or more operations of the container body manufacturing processes described herein.

In some embodiments, a method of applying a two-part corrosion inhibitor to a container body comprises applying a first material with a charge (or a first material possessing a charged area) to an interior surface of the container body, the interior surface comprising a porous coating. The first material is part 1 of a two-part corrosion inhibitor. In some embodiments, the first material has a positive charge. Alternatively, in other embodiments, the first material has a negative charge. The first material then migrates to most areas of the porous coating surface, and some of these areas do not have adequate corrosion protection.

The method further comprises applying a second material (part 2 of the two-part corrosion inhibitor) to the interior surface of the container body. The second material has an opposite charge (or an opposite charged area) compared to the first material. For example, when the first material has the positive charge, the second material has a negative charge, and vice versa. The opposite charges will bind the first material and the second material together causing them to be locked in place and thus providing corrosion protection at that site.

In some embodiments, one or more other materials may be added to (or applied with) the two-part corrosion inhibitor to improve one or more of the drying, curing, and absorption of the first material, the second material, or the first and second materials.

In some embodiments, a solvent is added to (or applied with) one or more of the first material and the second material. In some embodiments, the solvent is a liquid. The solvent may cause the internal coating to become softer (more porous) and allow the two-part corrosion inhibitor (or the first material and/or the second material) to be absorbed more quickly into the internal coating.

Any suitable solvent known to those of skill in the art may be used. In some embodiments, the solvent comprises one or more of: solvents that contain OH groups such as methanol, ethanol, propanol, isopropanol, butanol, and the like; 2-butoxyethanol; and other similar solvents known to those of skill in the art of metal packaging. Other suitable solvents include low molecular weight hydrocarbons such as butane, heptane, and hexane which could be volatized and evaporated from the container body.

Additionally, or alternatively, heat and/or energy may be applied to the two-part corrosion inhibitor. For example, the surface temperature of the container body may be raised to increase the speed of movement of the two-part corrosion inhibitor (or the first material and/or the second material) into the internal coating.

In some embodiments, light may be applied to the corrosion inhibitor to increase reaction rates of the two-part corrosion inhibitor. The light may be of any suitable wavelength. For example, the light may comprise visible light and/or UV light.

Optionally, vibrations may be used to improve performance of the corrosion inhibitor. For example, the container body may be exposed to ultrasonic waves to increase movement of the two-part corrosion inhibitor (or the first material and/or the second material) into the internal coating. The vibrations may also be used to improve dispersion of the two-part inhibitor.

In still other embodiments, an electrochemical process may be used to improve performance of the corrosion inhibitor. For example, a charge (negative or positive) may be applied to a metallic surface of the container body to cause the two-part corrosion inhibitor (or the first material and/or the second material) to be attracted to the metallic surface. In some embodiments, the two-part inhibitor can be introduced as an aerosol or dissolved in a liquid.

The two-part corrosion inhibitor may be applied in the manufacturing process in several different operations according to various embodiments of the present disclosure.

Applying a Two-Part Corrosion Inhibitor when Manufacturing a Metallic Bottle

In some embodiments, such as to manufacture a container body that is formed into a metallic bottle, the container body is formed as described herein. An internal coating is applied to an interior surface of the container body by an internal coater 124 and the internal coating is subsequently cured in an internal bake oven 126. The first material is applied (after the oven 126) to the interior surface on top of the cured internal coating. The container body is then necked in a necker 130. A thread is then formed on the neck. After the thread is formed, the second material is applied to the interior surface which already includes the first material. After the necking and the threading, the container body may be rinsed and subsequently dried in a final drier (or final dry-off oven).

In some embodiments, the second material is applied to the interior surface before the threaded container body is rinsed. Alternatively, in other embodiments, the second material is applied after the threaded container body is rinsed but before the final drying in the drier.

The first and second materials may be applied to the interior surface of the container body using any suitable method by any appropriate equipment known to those of skill in the art. In some embodiments, one or more of the first material and the second material are sprayed onto the interior surface by a sprayer.

Applying a Two-Part Corrosion Inhibitor when Manufacturing a Container Body or a Metallic Cup

In some embodiments, such as to manufacture a container body or a metallic cup, the container body or metallic cup is formed as described herein. An internal coating is applied to an interior surface by an internal coater 124 and the internal coating is subsequently cured in an internal bake oven 126. The first material is applied (after the oven 126) to the interior surface on top of the cured internal coating.

In some embodiments, the container body or metallic cup is transported through a first area to permit the first material to at least partially penetrate the internal coating. The first area may comprise fans or blowers. Additionally, or alternatively, the first area may comprise a heater or oven.

Optionally, the container body may proceed through a flanger 132, and a reprofiler/reformer 134 to complete the metal forming operations required to produce the container body. The second material is applied to the interior surface which already includes the first material.

In other embodiments, when a metallic cup is produced, after the container body leaves the area, other metal forming operations may be performed to produce the metallic cup. After the metal forming operations are completed to produce the metallic cup, the second material is applied to the interior surface which already includes the first material.

Optionally, the container body or the metallic cup may be transported through a second area to permit the second material to dry and/or to permit the second material to at least partially combine with the first material. The second area may comprise fans or blowers. Additionally, or alternatively, the second area may comprise a heater or oven.

A First Method of Applying a Two-Part Corrosion Inhibitor when Manufacturing a Container Body, a Metallic Cup, or a Metallic Bottle

In other embodiments, the two-part corrosion inhibitor may be applied according to another method used to manufacture a container body, a metallic cup, or a metallic bottle (collectively referred to as a workpiece). The workpiece is formed by a bodymaker 108, trimmed by a trimmer 110, and washed by a washer 112 as described herein. After the washer 112 and before the dryer 113 (i.e., Area 2), the first material is applied to the interior surface of the workpiece. The workpiece with the first material is then transported through the dryer 113 and one or more subsequent operations are performed. The workpiece then receives an internal coating from an internal coater 124 which is cured by an internal bake oven 126. The first material will be exposed in areas that did not receive the internal coating (or which were not adequately covered by the internal coating). Additionally, or alternatively, in some embodiments, the first material will migrate through the internal coating to areas of low, inadequate, or no coverage by the internal coating.

After the internal bake oven 126, the second material is applied to the interior surface on top of the first material and/or the internal coating. In this manner, the second material may combine with exposed portions of the first material, and the second material will coat the cured internal coating in area where the first material is not exposed.

The workpiece may optionally be transported to an area to permit the second material to at least partially penetrate into the internal coating and/or combine with the first material. Thereafter, the workpiece is transported to subsequent equipment where one or more operations are performed to form the workpiece into one of a container body, a metallic cup, or a metallic bottle.

A Second Method of Applying a Two-Part Corrosion Inhibitor when Manufacturing a Container Body, a Metallic Cup, or a Metallic Bottle

In still other embodiments, the two-part corrosion inhibitor may be applied according to a second method used to manufacture a container body, a metallic cup, or a metallic bottle (collectively referred to as a workpiece). The workpiece is formed by a bodymaker 108 as described herein. The workpiece is then transported to equipment which performs one or more subsequent operations.

The workpiece is subsequently transported to an internal coater 124. The first material is applied to an interior surface of the workpiece when the internal coater 124 applies an internal coating to the interior surface (i.e., at Area 4). As described herein, in some embodiments, the internal coater 124 may apply the first material of the two-part corrosion inhibitor approximately simultaneously with the internal coating. For example, the first material may be mixed with the corrosion inhibitor, and the mixture applied to the interior surface by a nozzle or sprayer of the internal coater. Alternatively, the first material may be applied by a first applicator of the internal coater before the internal coating is applied by a second applicator. In still other embodiments, the first material may be applied by a first applicator of the internal coater while the internal coating is applied by a second applicator. In yet another embodiment, the internal coating is applied by a first applicator of the internal coater before the first material is applied by a second applicator.

After the internal coater 124 applies the first material and the internal coating to the interior surface, the workpiece is transported through an internal bake oven 126 to cure the first material and the internal coating. The second material is subsequently applied on top of the first material and the internal coating. Optionally, the workpiece may optionally be transported to an area to permit the second material to at least partially penetrate into the internal coating and/or combine with the first material. Thereafter, the workpiece is transported to subsequent equipment where one or more operations are performed to form the workpiece into one of a container body, a metallic cup, or a metallic bottle.

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications that do not depart from the spirit and scope of the disclosure are deemed to be covered by the disclosure.

The foregoing discussion has been presented for purposes of illustration and description. The foregoing is not intended to limit the disclosure to the form or forms disclosed herein. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights that include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving case and/or reducing cost of implementation.

It is to be appreciated that any feature described herein may be claimed in combination with any other feature(s) as described herein, regardless of whether the features come from the same described embodiment.

What is claimed is:

1. A method of manufacturing a container body for a metallic container in a production line, comprising:
uncoiling a metallic sheet from a coil;
feeding the metallic sheet into a cupper;
cutting a circular blank from the metallic sheet in the cupper;
forming the circular blank into a cup;
pushing the cup through tooling of a bodymaker to redraw and iron the cup to form the container body;
trimming, by a trimmer, an open end of the container body;
washing the container body in a washer;
drying the container body in a dry-off oven;
applying, in an internal coater, an internal coating to an inner surface of the container body;
curing the internal coating in an internal bake oven;
forming, by a necker, a neck on the open end of the container body;
placing, by a palletizer, the container body onto a pallet; and
applying a first corrosion inhibitor to the inner surface of the container body at a first area of the production line.

2. The method of claim 1, wherein the first area is one of:
in the washer during the washing of the container body;
after the container body leaves the washer and before the container body enters the dry-off oven;
after the container body leaves the dry-off oven and before the container body enters the internal coater;
after the container body enters the internal coater and before the container body enters the internal bake oven;
after the container body leaves the internal bake oven and before the container body enters the necker; and
after the container body leaves the necker and before the container body is placed onto the pallet.

3. The method of claim 2, wherein the first corrosion inhibitor is selected from a first group consisting of polyphenols, terpenes, polysaccharides, vitamins, carboxylic acids, proteins, tannins, anthraquinones, amino acids, sterols, sugars, avonoids, and alkaloids.

4. The method of claim 2, further comprising applying a second corrosion inhibitor to the inner surface of the container body at a second area of the production line, the second area being different from the first area.

5. The method of claim 4, wherein the second corrosion inhibitor is selected from a second group consisting of polyphenols, terpenes, polysaccharides, vitamins, carboxylic acids, proteins, tannins, anthraquinones, amino acids, sterols, sugars, avonoids, and alkaloids.

6. The method of claim 4, wherein the second corrosion inhibitor is the same as the first corrosion inhibitor.

7. The method of claim 4, wherein the second corrosion inhibitor is different from the first corrosion inhibitor.

8. The method of claim 4, wherein the first corrosion inhibitor and the second corrosion inhibitor are different from the internal coating.

9. The method of claim 4, wherein the second area is one of:
in the washer during the washing of the container body;
after the container body leaves the washer and before the container body enters the dry-off oven;
after the container body leaves the dry-off oven and before the container body enters the internal coater;
after the container body enters the internal coater and before the container body enters the internal bake oven;
after the container body leaves the internal bake oven and before the container body enters the necker; and
after the container body leaves the necker and before the container body is placed onto the pallet.

10. The method of claim 1, further comprising providing the coil, wherein the metallic sheet comprises an aluminum.

11. The method of claim 1, wherein the first corrosion inhibitor is selected from a group consisting of compounds that contain phosphorus, nitrogen, sulfur, and oxygen atoms, and wherein the first corrosion inhibitor has multiple bonds in its structure.

12. A system to manufacture a container body for a metallic container in a production line, comprising:
an uncoiler to uncoil a metallic sheet from a coil;
a cupper to receive the metallic sheet from the uncoiler, the cupper configured to cut a circular blank from the metallic sheet and form the circular blank into a cup;
a bodymaker to redraw and iron the cup to form the container body;
a trimmer to trim an open end of the container body, the trimmer being downstream from the bodymaker;
a washer to wash the container body, the washer being downstream from the trimmer;
a dry-off oven to dry the container body, the dry-off oven being downstream from the washer;
an internal coater to apply an internal coating to an inner surface of the container body, the internal coater being downstream from the dry-off oven;
an internal bake oven to cure the internal coating, the internal bake oven being downstream from the internal coater;
a necker to form a neck on the open end of the container body, the necker being downstream from the internal bake oven;
a palletizer to place the container body onto a pallet, the palletizer being downstream from the necker; and
a first applicator to apply a first corrosion inhibitor to the inner surface of the container body, wherein the first applicator is positioned at a first area of the production line.

13. The system of claim 12, wherein the first area is one of:
in the washer;
downstream from the washer and before the dry-off oven;
downstream from the dry-off oven and before the internal coater;
between an entrance to the internal coater and before the internal bake oven;
downstream from the internal bake oven and before the necker; and
downstream from the necker and before the palletizer.

14. The system of claim 13, wherein the first corrosion inhibitor is selected from a first group consisting of polyphenols, terpenes, polysaccharides, vitamins, carboxylic acids, proteins, tannins, anthraquinones, amino acids, sterols, sugars, avonoids, and alkaloids.

15. The system of claim 13, further comprising a second applicator to apply a second corrosion inhibitor to the inner surface of the container body, wherein the second applicator is positioned at a second area of the production line, the second area being different from the first area.

16. The system of claim 15, wherein the second corrosion inhibitor is selected from a second group consisting of polyphenols, terpenes, polysaccharides, vitamins, carboxylic acids, proteins, tannins, anthraquinones, amino acids, sterols, sugars, avonoids, and alkaloids.

17. The system of claim 15, wherein the first corrosion inhibitor and the second corrosion inhibitor are different from the internal coating, and wherein the second corrosion inhibitor is one of:
the same as the first corrosion inhibitor; and
different from the first corrosion inhibitor.

18. The system of claim 15, wherein the second area is one of:
in the washer;
downstream from the washer and before the dry-off oven;
downstream from the dry-off oven and before the internal coater;
between an entrance to the internal coater and before the internal bake oven;
downstream from the internal bake oven and before the necker; and
downstream from the necker and before the palletizer.

19. The system of claim 12, wherein the first corrosion inhibitor is selected from a group consisting of compounds that contain phosphorus, nitrogen, sulfur, and oxygen atoms, and wherein the first corrosion inhibitor has multiple bonds in its structure.

20. The system of claim 12, wherein the first applicator is adapted to apply between about 50 picograms and about 500 mg of the first corrosion inhibitor to the inner surface.

21. A container body, comprising:
a closed end;
a sidewall extending from the closed end to an open end defining an opening, wherein the container body has an inner surface and an outer surface, and wherein the container body is formed of a metallic material;
an internal coating positioned on at least a majority of the inner surface of the container body; and
a corrosion inhibitor positioned on at least a majority of the inner surface of the container body.

22. The container body of claim 21, further comprising between about 50 picograms and about 500 mg of the corrosion inhibitor.

23. The container body of claim 21, wherein the corrosion inhibitor is mixed with the internal coating and is applied to the inner surface of the container body in a heterogeneous layer.

24. The container body of claim 21, wherein the corrosion inhibitor is positioned directly on the inner surface of the container body such that the corrosion inhibitor is positioned between the internal coating and the inner surface of the container body.

25. The container body of claim 21, wherein the internal coating is positioned directly on the inner surface of the container body such that the internal coating is positioned between the corrosion inhibitor and the inner surface of the container body.

26. The container body of claim 21, wherein the corrosion inhibitor is selected from a group consisting of polyphenols, terpenes, polysaccharides, vitamins, carboxylic acids, proteins, tannins, anthraquinones, amino acids, sterols, sugars, avonoids, and alkaloids.

27. The container body of claim 21, wherein the corrosion inhibitor is selected from a group consisting of compounds that contain phosphorus, nitrogen, sulfur, and oxygen atoms, and wherein the corrosion inhibitor has multiple bonds in its structure.
